(19) United States
(12) Patent Application Publication
(10) Pub. No.: US 2015/0109655 A1
(43) Pub. Date: Apr. 23, 2015

(54) FUNCTIONAL MULTILAYER SYSTEM

(71) Applicant: Université de Namur, Namur (BE)

(72) Inventors: Jean-Pol Vigneron, Vedrin (BE); Olivier Deparis, Vaulx-Lez-Chimay (BE); Priscilla Simonis, Ciney (BE); Eric Gaigneaux, Blanmont (BE); Mohammed N. Ghazzal, Casablanca (MA); Joël De Coninck, Mesvin (BE); Hakim Kebaïli, Bois-Colombes (FR)

(73) Assignee: Universite de Namur, Namur (BE)

(21) Appl. No.: 14/398,067

(22) PCT Filed: Apr. 25, 2013
(86) PCT No.: PCT/EP2013/058668

§ 371 Date: Oct. 30, 2014

(30) Foreign Application Priority Data
Apr. 30, 2012 (EP) 12166155.7

(51) Int. Cl. G02B 26/00; G02B 26/08

(52) U.S. Cl. CPC G02B 26/004; G02B 26/08
USPC 359/290; 427/162

(57) ABSTRACT

Functional multilayer systems and are used in the manufacture of various devices such as detecting and sensor devices. More specifically, porous multilayer systems are capable of switching from a transparent state to a Bragg reflector state by introducing a suitable composition into the porous multilayer system, or via displacement of a suitable composition through the porous multilayer system.

### TECHNICAL FIELD OF THE INVENTION

The present invention is directed to new functional multilayer systems and their use in the manufacture of various devices such as detecting and sensor devices. More specifically, the present invention relates to porous multilayer systems capable of switching from a transparent state to a Bragg reflector state by introducing a suitable composition into the porous multilayer system, or via displacement of a suitable composition through the porous multilayer system.

### BACKGROUND OF THE INVENTION

Systems comprising a multilayer structure possessing various optical properties are well known in the art and have been used for many years now.

Most commonly known materials correspond to the so-called interference filters or Bragg reflectors which are capable of selectively reflecting or transmitting a range of electromagnetic frequencies or radiations, generally comprised between the ultraviolet and the infra-red zone of the electromagnetic spectrum.

In typical configurations, such Bragg-type reflectors materials are formed by depositing alternating layers of dielectric materials on a substrate. In that context, highly reflective materials may be obtained by alternating layers of materials having high and low indices of refraction, forming a stack of dielectric layers.

Conventional reflectors, however, can have physical and optical limitations that prevent their use in some specific applications. In particular, an increasing need has recently emerged for more complex multifunctional systems or materials. Among these more elaborated systems, particular attention has been dedicated to versatile materials capable of exhibiting changing electromagnetic properties which are directly dependent upon application of an external stimulus, such as mechanical stimulus, chemical stimulus, electrical stimulus, thermal stimulus or magnetic stimulus.

WO 2009/143625 discloses a tunable photonic crystal device (also described as distributed Bragg reflector) comprising alternating layers of a first material and a second material, the alternating layers comprising a responsive material being responsive to an external stimulus; wherein, in response to the external stimulus, a change in the responsive material results in a shifting of the reflected wavelength of the device.

EP-A2-0919604 describes a colour-change material comprising a reversibly thermochromic layer comprising a reversibly thermochromic material and a porous layer containing a low-refractive-index pigment; wherein the colour-change material changes its colour in response to heat or water.

EP-A1-2080794 discloses a colour-change laminate comprising a support having a metallic lustrous property and a porous layer provided on the surface of the support, wherein the porous layer comprises a low-refractive-index pigment and a transparent metallic lustrous pigment formed by coating a transparent core material with a metal oxide and/or a transparent metallic lustrous pigment having a colour-flopping property all fixed onto a binder resin in a dispersed state and is different in transparency in a liquid-absorbed state and in a liquid-unabsorbed state.

WO 2005/096066 describes a (electrowetting) display element comprising at least two porous layers, a conductive liquid residing in the upper layer, the liquid having a contact angle with the material of the upper layer of less than about 60°, the material of the lower layer being conductive and insulated from the liquid with a dielectric covering, the liquid having a contact angle with the material of the lower layer of greater than about 90°, whereby on application of a voltage between the lower layer and the liquid, the liquid moves out of the upper layer in to the lower layer thereby effective on optical change in the upper layer.

EP 2 116 872 A1 discloses a multilayer (mesoporous) structure formed by nanoparticular lamina with unidimensional photonic crystal properties, method for the production thereof and use thereof.

Sung Yeun Choi et al. discloses in “Mesoporous Bragg Stack Color Tunable Sensors”, in Nano Lett., Vol. 6, No. 11, 2006, p 2456-2461, a self-assembly synthesis, structural and optical characterization of mesoporous Bragg stacks composed of spin-coated multilayer stacks of mesoporous TiO₂ and mesoporous SiO₂.

Without contesting the advantages associated with the above-mentioned devices, there is still a need for a functional multilayer system which is capable of switching from a transparent state to a Bragg reflector state.

It is therefore one aim of the present invention to provide a single system which is designed such that it is capable of conveniently and easily shifting from a transparent state to a Bragg reflector state (also referred to as Bragg mirror state) when exposed to an incident electromagnetic radiation.

It has now been found that the above objective may be fulfilled by providing a porous multilayer system according to the present invention.

Advantageously, the multilayer system according to the invention is capable of reversibly switching from a transparent state to a Bragg reflector state via simple displacement of a suitably selected composition through the multilayer system.

Other advantages and more specific properties of the porous multilayer system according to the present invention will be clear after reading the following description of the invention in combination with the attached drawings.

### SUMMARY OF THE INVENTION

According to one aspect of the present invention, it is provided a porous multilayer system (1) comprising at least one bilayer (4) consisting of two porous layers (L₁) (2) and (L₂) (3), wherein porous layer (L₁) (2) and porous layer (L₂) (3) comprise respectively a host material (h₁) and a host material (h₂), wherein the refractive index (n₁) of the host material (h₁) in porous layer (L₁) (2) is different from the refractive index (n₂) of the host material (h₂) in porous layer (L₂) (3), wherein porous layer (L₁) (2) and porous layer (L₂) (3) further comprise respectively a (initial) pore material (p₁) and a (initial) pore material (p₂), said porous multilayer system (1) having a (overall) (initial) reflectance (Rᵢₙᵢₜᵢₐₗ) with respect to an incident electromagnetic radiation being minimal, and (accordingly) a (overall) (initial) transmittance (Tᵢₙᵢₜᵢₐₗ) with respect to an incident electromagnetic radiation being maximal, said (overall) (initial) reflectance (Rᵢₙᵢₜᵢₐₗ) and said (overall) (initial) transmittance (Tᵢₙᵢₜᵢₐₗ) corresponding to a (initial) state (Sᵢₙᵢₜᵢₐₗ) of the porous multilayer system (1), wherein said porous multilayer system (1) is capable of (reversibly or irreversibly) switching (or shifting) from (initial) state (Sᵢₙᵢₜᵢₐₗ) to (final) state (S_{final}), wherein (S_{final}) corresponds to the state wherein the (overall) (final) reflectance (R_{final}) of the porous multilayer system (1) is maximal, and (accordingly) the (overall) (final) transmittance (T_{final}) is minimal.

Preferably, in the porous multilayer system according to the invention, said (initial) pore material (p₁) and (initial) pore material (p₂) is air or a (mixture of) inert gas(es), said porous multilayer system (1) having a (overall) (initial) reflectance (R₁) with respect to an incident electromagnetic radiation being comprised between (about) 0% to (about) 25%, more preferably being (about) 0%, and (accordingly) a (overall) (initial) transmittance (T₁) with respect to an incident electromagnetic radiation being comprised between (about) 75% to (about) 100%, more preferably being (about) 100%, said (overall) (initial) reflectance (R₁) and said (overall) (initial) transmittance (T₁) corresponding to a (initial) state (S₁) of the porous multilayer system (1), wherein said porous multilayer system (1) is capable of (reversibly or irreversibly) switching (or shifting) from (initial) state (S₁) (or transparent state) to (final) state (S₂) (or mirror state) by introducing a composition (C) (7) (other than air or inert gas) into said porous multilayer system (1), wherein (the final state) (S₂) corresponds to the state wherein the (overall) (final) reflectance (R₂) of the porous multilayer system (1) comprising said composition (C) (7) is comprised between (about) 60% and (about) 100%, more preferably is (about) 100%, and (accordingly) the (overall) (final) transmittance (T₂) is comprised between (about) 0% and (about) 40%, more preferably is (about) 0%.

More preferably, the porous multilayer system according to the invention is further capable of switching (back) from state (S₂) (or mirror state) to state (S₁) (or transparent state) by (substantially complete) removing said composition (C) (7) (other than air or inert gas) from said porous multilayer system (1).

Even more preferably, the porous multilayer system according to the invention is capable of (reversibly or irreversibly) switching from state (S₁) (or transparent state) to state (S₂) (or mirror state) by introducing a composition (C) (7) (other than air or inert gas) into porous layer (L₁) (2) and/or porous layer (L₂) (3), most preferably into the pores (5) of porous layer (L₁) (2) and/or the pores (6) of porous layer (L₂) (3), and/or is capable of switching (back) from state (S₂) (or mirror state) to state (S₁) (or transparent state) by (substantially complete) removing a composition (C) (7) (other than air or inert gas) from porous layer (L₁) (2) and/or porous layer (L₂) (3), most preferably from the pores (5) of porous layer (L₁) (2) and/or the pores (6) of porous layer (L₂) (3).

More preferably, the porous multilayer system according to the invention further comprises a composition (C) (7) (other than air or inert gas) present in any of porous layer (L₁) (2) and/or (L₂) (3), even more preferably present in the pores (5,6) of any of porous layer (L₁) (2) and/or (L₂) (3).

Alternatively, in the porous multilayer system according to the invention, said (initial) pore material (p₁) or (initial) pore material (p₂) is a composition (C) (7) (other than air or inert gas), said porous multilayer system (1) comprising said composition (C) (7) having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly) switching from state (S₁′) (or transparent state) to (final) state (S₂) (or mirror state) and/or (back) from state (S₂) (or mirror state) to (initial) state (S₁′) (or transparent state) via displacement of a composition (C) (7) (other than air or inert gas) through said porous multilayer system (1), more preferably from the pores (5) of porous layer (L₁) (2) to the pores (6) of porous layer (L₂) (3) or from the pores (6) of porous layer (L₂) (3) to the pores (5) of porous layer (L₁) (2), wherein (the final state) (S₂) corresponds to the state wherein the (overall) (final) reflectance (R₂) of the porous multilayer system (1) comprising said composition (C) (7) is comprised between (about) 60% and (about) 100%, more preferably is (about) 100%, and (accordingly) the (overall) (final) transmittance (T₂) is comprised between (about) 0% and (about) 40%, more preferably is (about) 0%.

More preferably, in the porous multilayer system according to the invention, said (initial) pore material (p₁) is a composition (C) (7) (other than air or inert gas) and said (initial) pore material (p₂) is air or inert gas, said porous multilayer system being capable of (reversibly) switching from (initial) state (S₁′) (or transparent state) to (final) state (S₂) (or mirror state) via (substantially) complete displacement of said composition (C) (7) (other than air or inert gas) from the pores (5) of porous layer (L₁) (2) to the pores (6) of porous layer (L₂) (3), and said porous multilayer system being capable of switching (back) from (final) state (S₂) (or mirror state) to (initial) state (S₁′) (or transparent state) via (substantially) complete displacement of said composition (C) (7) (other than air or inert gas) from the pores (6) of porous layer (L₂) (3) to the pores (5) of porous layer (L₁) (2).

More preferably, in the porous multilayer system according to the invention, said (initial) pore material (p₁) is air or inert gas and (initial) pore material (p₂) is a composition (C) (7) (other than air or inert gas), said porous multilayer system being capable of (reversibly) switching from state (S₁′) (or transparent state) to state (S₂) (or mirror state) via (substantially) complete displacement of said composition (C) (7) (other than air or inert gas) from the pores (6) of porous layer (L₂) (3) to the pores (5) of porous layer (L₁) (2), and said porous multilayer system being capable of switching (back) from state (S₂) (or mirror state) to state (S₁′) (or transparent state) via (substantially) complete displacement of said composition (C) (7) (other than air or inert gas) from the pores (5) of porous layer (L₁) (2) to the pores (6) of porous layer (L₂) (3).

Preferably, in the porous multilayer system according to the invention, (n₁)<(n₂).

More preferably, in the porous multilayer system according to the invention, the porous layer (L₁) (2) is hydrophobic and porous layer (L₂) (3) is hydrophilic.

Preferably, in the porous multilayer system according to the invention, the composition (C) (7) (other than air or inert gas) is selected from the group consisting of liquid compositions, vapor compositions, and combinations thereof.

Preferably, in the porous multilayer system according to the invention, the composition (C) (7) is selected from liquid compositions, preferably from aqueous compositions, more preferably said composition is water.

Preferably, in the porous multilayer system according to the invention, the incident electromagnetic radiation ranges from long waves (or radio waves) radiations to gamma rays, preferably from microwaves to X-rays radiations, more preferably from infrared to ultraviolet radiations, most preferably said incident electromagnetic radiation is visible light.

Preferably, in the porous multilayer system according to the invention, (the host material (h₁) in) porous layer (L₁) (2) comprises (or consists of) silicon, more preferably comprises silicon oxide, even more preferably (the host material (h₁) in) porous layer (L₁) (2) consists of silicon oxide.

Preferably, in the porous multilayer system according to the invention, (the host material (h₂) in) porous layer (L₂) (3) comprises (or consists of) titanium, more preferably comprises titanium oxide, even more preferably (the host material (h₂) in) porous layer (L₂) (3) consists of titanium oxide.

Preferably, in the porous multilayer system according to the invention, (the host material (h₁) in) porous layer (L₁) (2) comprises (or consists of) silicon oxide, (the host material (h₂) in) porous layer (L₂) (3) comprises (or consists of) titanium oxide, and composition (C) (7) is water.

Preferably, in the porous multilayer system according to the invention, the (initial) pore volume fraction (fₚₒᵣₑ₁) of porous layer (L₁) (2) and the (initial) pore volume fraction (fₚₒᵣₑ₂) of porous layer (L₂) (3) are such that said (initial) (fₚₒᵣₑ₁) and said (initial) (fₚₒᵣₑ₂) satisfy the following equation:

$${f}_{pore 2} = {f}_{pore 1} \frac{β ( {u}_{1}^{p} ) - β ( {u}_{1}^{h} )}{β ( {u}_{2}^{p} ) - β ( {u}_{2}^{h} )} + \frac{β ( {u}_{1}^{h} ) - β ( {u}_{2}^{h} )}{β ( {u}_{2}^{p} ) - β ( {u}_{2}^{h} )} \qquad ( 1 )$$

wherein

$$β ( {u}_{i}^{p} ) = \frac{1 - {u}_{i}^{p}}{{u}_{i}^{p} ( 1 - {Γ}_{i} ) + 1} ;$$

$$β ( {u}_{i}^{h} ) = \frac{1 - {u}_{i}^{h}}{{u}_{i}^{h} ( 1 - {Γ}_{i} ) + 1} ;$$

$${u}_{i}^{p} = \frac{\overline{ɛ}}{{ɛ}_{i}^{p}} ;$$

$${u}_{i}^{h} = \frac{\overline{ɛ}}{{ɛ}_{i}^{h}} ;$$

wherein i=1 or 2;
wherein ε̅ is the effective dielectric constant (or transparency effective dielectric constant) in (initial) state (S₁) or in (initial) state (S₁′); wherein ε̅= n̅², n̅ being the effective refractive index (or transparency effective refractive index) in (initial) state (S₁) or in (initial) state (S₁′); wherein εᵢ^{p}=(nᵢ^{p})², εᵢ^{p} being the dielectric constant of pore material (p₁) in porous layer (L₁); wherein εᵢ^{h}=(nᵢ^{h})², εᵢ^{h} being the dielectric constant of host material (h₁) in porous layer (L₁); and wherein (Γ₁) is the depolarization factor of porous layer (L₁).

According to a preferred aspect of the porous multilayer system according to the invention, said (initial) pore material (p₁) is air and said (initial) pore material (p₂) is air, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) having a (overall) (initial) reflectance (R₁) with respect to an incident electromagnetic radiation being comprised between (about) 0% to (about) 25%, more preferably being (about) 0%, and (accordingly) a (overall) (initial) transmittance (T₁) with respect to an incident electromagnetic radiation being comprised between (about) 75% to (about) 100%, more preferably being (about) 100%, said (overall) (initial) reflectance (R₁) and said (overall) (initial) transmittance (T₁) corresponding to a (initial) state (S₁) of the porous multilayer system (1), said porous multilayer system (1) is capable of (reversibly or irreversibly) switching (or shifting) from (initial) state (S₁) (or transparent state) to (final) state (S₂) (or mirror state) by introducing a composition (C) (7) (other than air or inert gas) into said porous multilayer system (1), wherein (the final state) (S₂) corresponds to the state wherein the (overall) (final) reflectance (R₂) of the porous multilayer system (1) comprising said composition (C) (7) is comprised between (about) 60% and (about) 100%, more preferably is (about) 100%, and (accordingly) the (overall) (final) transmittance (T₂) is comprised between (about) 0% and (about) 40%, more preferably is (about) 0%, and the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.424×fₚₒᵣₑ₁+0.560 (2)

According to another preferred aspect of the porous multilayer system according to the invention, said (initial) pore material (p₁) is water and said (initial) pore material (p₂) is air, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly) switching from state (S₁′) (or transparent state) to (final) state (S₂) (or mirror state) and/or (back) from state (S₂) (or mirror state) to (initial) state (S₁′) (or transparent state) via displacement of said water through said porous multilayer system (1), more preferably from the pores (5) of porous layer (L₁) (2) to the pores (6) of porous layer (L₂) (3) or (back) from the pores (6) of porous layer (L₂) (3) to the pores (5) of porous layer (L₁) (2), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.164×fₚₒᵣₑ₁+0.572 (3)

According to yet another preferred aspect of the porous multilayer system according to the invention, said (initial) pore material (p₁) is air and (initial) pore material (p₂) is water, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly) switching from state (S₁′) (or transparent state) to (final) state (S₂) (or mirror state) and/or (back) from state (S₂) (or mirror state) to (initial) state (S₁′) (or transparent state) via displacement of said water through said porous multilayer system (1), more preferably from the pores (6) of porous layer (L₂) (3) to the pores (5) of porous layer (L₁) (2) or (back) from the pores (5) of porous layer (L₁) (2) to the pores (6) of porous layer (L₂) (3), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.703×fₚₒᵣₑ₁+0.714 (4)

Preferably, the porous multilayer system according to the invention, comprises any of 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 bilayers (4) consisting of two porous layers (L₁) (2) and (L₂) (3), more preferably said porous multilayer comprises less than 30, even more preferably less than 20, yet more preferably less than 10, most preferably less than 5 of said bilayers (4).

According to another aspect of the present invention, it is provided a method of manufacturing a porous multilayer system as above-described, which comprises the step of:
a) selecting at least one bilayer (4) consisting of two porous layers (L₁) (2) and (L₂) (3) wherein porous layer (L₁) (2) and porous layer (L₂) (3) comprise respectively a host material (h₁) and a host material (h₂), wherein porous layer (L₁) (2) and porous layer (L₂) (3) further comprise respectively a (initial) pore material (p₁) and a (initial) pore material (p₂), said (initial) pore material (p₁) and (initial) pore material (p₂) being air or a (mixture of) inert gas(es), wherein the refractive index (n₁) of the host material (h₁) in porous layer (L₁) (2) is different from the refractive index (n₂) of the host material (h₂) in porous layer (L₂) (3);
b) selecting a suitable composition (C) (7);
c) establishing by theoretical modeling of reflectance (R) and transmittance (T) spectra whether achieving state (S₁) is possible for a theoretical porous multilayer system (1) comprising said at least one bilayer (4) when composition (C) (7) is absent from said porous multilayer system (1);
d) theoretically determining the technical conditions for the porous multilayer system (1) to achieve state (S₁);
e) determining whether achieving state (S₂) is possible for the same porous multilayer system (1) by introducing a composition (C) (7) into porous layer (L₁) (2) and/or porous layer (L₂) (3), preferably into the pores (5) of porous layer (L₁) (2) and/or the pores (6) of porous layer (L₂) (3);
f) theoretically determining the technical conditions for the porous multilayer system (1) to achieve state (S₂);
g) combining the technical conditions necessary for the same porous multilayer to be capable of (reversibly or irreversibly) switching from state (S₁) (or transparent state) to state (S₂) (or mirror state) by introducing a composition (C) (7) to porous layer (L₁) (2) and/or porous layer (L₂) (3), preferably into the pores (5) of porous layer (L₁) (2) and/or the pores (6) of porous layer (L₂) (3);
h) forming said at least one bilayer (4) consisting of two porous layers (L₁) (2) and (L₂) (3) so as to form a porous multilayer system (1) meeting the combined technical conditions as mentioned above; and
i) optionally, introducing said composition (C) (7) into said porous multilayer system (1), preferably into porous layer (L₁) (2) and/or porous layer (L₂) (3), more preferably into the pores (5) of porous layer (L₁) (2) and/or the pores (6) of porous layer (L₂) (3).

According to yet another aspect of the present invention, it is provided a method of manufacturing a porous multilayer system as above-described method of manufacturing a porous multilayer system, which comprises the step of:
a) selecting at least one bilayer (4) consisting of two porous layers (L₁) (2) and (L₂) (3) wherein porous layer (L₁) (2) and porous layer (L₂) (3) comprise respectively a host material (h₁) and a host material (h₂), wherein porous layer (L₁) (2) and porous layer (L₂) (3) further comprise respectively a (initial) pore material (p₁) and a (initial) pore material (p₂), said (initial) pore material (p₁) or (initial) pore material (p₂) being a (suitable) composition (C) (7) (other than air or a (mixture of) inert gas(es)), wherein the refractive index (n₁) of the host material (h₁) in porous layer (L₁) (2) is different from the refractive index (n₂) of the host material (h₂) in porous layer (L₂) (3);
b) establishing by theoretical modeling of reflectance (R) and transmittance (T) spectra whether achieving state (S₁′) is possible for a theoretical porous multilayer system (1) comprising said at least one bilayer (4) when composition (C) (7) is present in said porous multilayer system (1), preferably in porous layer (L₁) (2), more preferably in the pores (5) of porous layer (L₁) (2);
c) theoretically determining the technical conditions for the porous multilayer system (1) to achieve state (S₁′);
d) determining whether achieving state (S₂) is possible for the same porous multilayer system (1) via displacement of composition (C) (7) through said porous multilayer system (1), preferably via displacement of composition (C) (7) from porous layer (L₁) (2) to porous layer (L₂) (3), more preferably via displacement of composition (C) (7) from the pores (5) of porous layer (L₁) (2) to the pores (6) of porous layer (L₂) (3);
e) theoretically determining the technical conditions for the porous multilayer system (1) to achieve state (S₂);
f) combining the technical conditions necessary for the same porous multilayer to be capable of (reversibly or irreversibly) switching from state (S₁′) (or transparent state) to state (S₂) (or mirror state) via displacement of composition (C) (7) through said porous multilayer, preferably via displacement of composition (C) (7) from porous layer (L₁) (2) to porous layer (L₂) (3), more preferably via displacement of composition (C) (7) from the pores (5) of porous layer (L₁) (2) to the pores (6) of porous layer (L₂) (3);
g) forming said at least one bilayer consisting of two porous layers (L₁) (2) and (L₂) (3) so as to form a porous multilayer system (1) meeting the combined technical conditions as mentioned above.

According to still another aspect, the present invention relates to the use of a porous multilayer system as above-described for the manufacture of a device selected from the group consisting of detecting devices, sensing devices, actuating devices, logical optoelectronic devices, photovoltaic devices, solar cell devices, communication devices, alerting devices, displaying devices, optical devices, smart glazing, hygrochromic devices, and combinations thereof.

Preferably, the porous multilayer system as above-described is used for the manufacture of hygrochromic devices.

According to yet another aspect of the present invention, it is provided a device selected from the group consisting of sensing devices, communication devices, alerting devices, displaying devices, optical devices, logical optoelectronic devices, smart glazing, so-called hygrochromic devices, and combinations thereof; wherein the device comprises a porous multilayer system as above-described.

Preferably, the device comprising a porous multilayer system as above-described, is selected from hygrochromic devices.

### BRIEF DESCRIPTION OF THE DRAWINGS

FIG. 1 schematically depicts one exemplary execution of a porous multilayer system according to the present invention which is coated on a substrate, wherein the porous multilayer system comprises three identical bilayers consisting of a porous layer (L₁) and a porous layer (L₂).

FIG. 2 schematically depicts (part of) the porous multilayer system of FIG. 1 which further comprises a composition (C) and which is in state (S₁), i.e. in a transparent state.

FIG. 3 schematically depicts (part of) the porous multilayer system of FIG. 1 which further comprises a composition (C) and which is in state (S₂), i.e. in a so-called Bragg reflector state (also referred to as a Bragg mirror state).

FIG. 4 depicts the transmittance spectrum (at normal incidence) in dry state and wet state for porous multilayer sample A.

FIG. 5 depicts the transmittance spectrum (at normal incidence) in dry state and wet state for porous multilayer sample B.

FIG. 6 depicts the transparency condition (or transparency curve) for 4 different combinations of pore filling using either air or water as pore material.

FIG. 7a and FIG. 7b each depict the transparency relationship and the maximum reflectance contrast that can be achieved for a porous multilayer system consisting of three 105/65 nm thick SiO₂/TiO₂ bilayers.

FIG. 8 depicts the transparency master curve calculated for L₂ and L₁ layers consisting in, respectively, 50% TiO₂-50% Al₂O₃ and SiO₂ porous oxides.

FIG. 9 depicts the transmittance spectra (normal incidence) of mesoporous 1D photonic crystal (PC) coatings in which increasing ratios of alumina oxides were added to the high-refractive-index titania oxide.

FIG. 10 depicts the transmittance spectra of a mesoporous 1D photonic crystal coating before and after filling of the pores with water (solid curves: measurements, dotted curves: theoretical predictions). The composition of the high-refractive-index layers is 50% TiO₂-50% Al₂O₃. The 1D photonic crystal coating consists of three bilayers of 50% TiO₂-50% Al₂O₃ and SiO₂ oxides on glass substrate.

### DETAILED DESCRIPTION OF THE INVENTION

According to one aspect of the present invention, it is provided a porous multilayer system (1) comprising at least one bilayer (4) consisting of two porous layers (L₁) (2) and (L₂) (3), wherein porous layer (L₁) (2) and porous layer (L₂) (3) comprise respectively a host material (h₁) and a host material (h₂), wherein the refractive index (n₁) of the host material (h₁) in porous layer (L₁) (2) is different from the refractive index (n₂) of the host material (h₂) in porous layer (L₂) (3), wherein porous layer (L₁) (2) and porous layer (L₂) (3) further comprise respectively a (initial) pore material (p₁) and a (initial) pore material (p₂), said porous multilayer system (1) having a (overall) (initial) reflectance (Rᵢₙᵢₜᵢₐₗ) with respect to an incident electromagnetic radiation being minimal, and (accordingly) a (overall) (initial) transmittance (Tᵢₙᵢₜᵢₐₗ) with respect to an incident electromagnetic radiation being maximal, said (overall) (initial) reflectance (Rᵢₙᵢₜᵢₐₗ) and said (overall) (initial) transmittance (Tᵢₙᵢₜᵢₐₗ) corresponding to a (initial) state (Sᵢₙᵢₜᵢₐₗ) of the porous multilayer system (1), wherein said porous multilayer system (1) is capable of (reversibly or irreversibly, preferably reversibly) switching (or shifting) from (initial) state (Sᵢₙᵢₜᵢₐₗ) to (final) state S_{final}) wherein (S_{final}) corresponds to the state wherein the (overall) (final) reflectance (R_{final}) of the porous multilayer system (1) is maximal, and (accordingly) the (overall) (final) transmittance (T_{final}) minimal.

In the context of the present invention, the term “host material of a porous layer” is meant to refer solely to the constituting material of the porous layer, i.e. without the pores.

In the context of the present invention, the expression “reflectance (R) of the porous multilayer system” is meant to represent the reflectance of the overall multilayer material measured by appropriate means, when the multilayer material system is exposed to an incident electromagnetic radiation.

In the following description, the expressions “incident electromagnetic radiations”, “incident electromagnetic wavelengths”, “incident electromagnetic frequencies” may be used interchangeably.

In the context of the present invention, the expression “transmittance (T) of the porous multilayer system” is meant to represent the transmittance of the overall multilayer material measured by appropriate means when the multilayer material is exposed to an incident electromagnetic radiation.

In the context of the present invention, the term “transmittance is maximal” is meant to represent the maximum transmission coefficient that can be measured by appropriate means when the multilayer material is exposed to an incident electromagnetic radiation.

Similarly, and in the context of the present invention, the term “reflectance is maximal” is meant to represent the maximum reflective coefficient that can be measured by appropriate means when the multilayer is exposed to an incident electromagnetic radiation.

Preferably, the porous multilayer system according to the invention comprises at least two bilayers each consisting of two porous layers (L₁) (2) and (L₂) (3).

Preferably, in the porous multilayer system according to the invention, said (initial) pore material (p₁) and (initial) pore material (p₂) is air or a (mixture of) inert gas(es), said porous multilayer system (1) having a (overall) (initial) reflectance (R₁) with respect to an incident electromagnetic radiation being comprised between (about) 0% to (about) 25%, more preferably being (about) 0%, and (accordingly) a (overall) (initial) transmittance (T₁) with respect to an incident electromagnetic radiation being comprised between (about) 75% to (about) 100%, more preferably being (about) 100%, said (overall) (initial) reflectance (R₁) and said (overall) (initial) transmittance (T₁) corresponding to a (initial) state (S₁) of the porous multilayer system (1), wherein said porous multilayer system (1) is capable of (reversibly or irreversibly, preferably reversibly) switching (or shifting) from (initial) state (S₁) (or transparent state) to (final) state (S₂) (or mirror state) by introducing a composition (C) (7) (other than air or inert gas) into said porous multilayer system (1), wherein (the final state) (S₂) corresponds to the state wherein the (overall) (final) reflectance (R₂) of the porous multilayer system (1) comprising said composition (C) (7) is comprised between (about) 60% and (about) 100%, more preferably is (about) 100%, and (accordingly) the (overall) (final) transmittance (T₂) is comprised between (about) 0% and (about) 40%, more preferably is (about) 0%.

More particularly, (initial) pore material (p₁) and (initial) pore material (p₂) are identical.

The porous multilayer system (1) of the invention being in (initial) state (S₁) does not comprise any (liquid) composition (C) (or in (initial) state (S₁) no composition (C) is present in any of the layers of the porous multilayer system (1) of the invention. In other words, said (initial) pore material (p₁) and (p₂) being air or a (mixture of) inert gas(es), said porous multilayer system (1) is said to be (substantially) “dry” or in a “dry state”, or said porous layer (L₁) (2) and porous layer (L₂) (3) are said to be (substantially) “dry”).

In the context of the present invention, the wording “a porous layer (L₁) is (substantially) dry” refers to (all) the pores of porous layer (L₁) being filled with air or with a (mixture of) inert gas(es).

In the porous multilayer system (1) of the invention, the (overall) (initial) reflectance (R₁) is different from the (overall) (final) reflectance (R₂); and the (overall) (initial) transmittance (T₁) is different from the (overall) (final) transmittance (T₂).

More preferably, a porous layer (L₁) of the invention comprises a (total) host material (h_{i,tot}), said (h_{i,tot}) comprising (or consisting of) (a mixture of) (at least) 2 host materials (hᵢ) and (hⱼ) (or (h_{i,tot})=(hᵢ)+(hⱼ)).

The corresponding (total) dielectric constant (or (total) refractive index n_{i,tot}) is that of (the mixture of) the (at least) 2 host materials (hᵢ) and (hⱼ) (or (h_{i,tot)).}

More particularly, the porous layer (L₂) of the invention comprises a (total) host material (h_{2,tot}), said (h_{2,tot}) comprising (or consisting of) (a mixture of) (at least) 2 host materials (h₂) and (h₃) (or (h_{2,tot})=(h₂)+(h₃)).

The corresponding (total) dielectric constant (or (total) refractive index n_{2,tot}) is that of (the mixture of) the (at least) 2 host materials (h₂) and (h₃) (or (h_{2,tot})).

More particularly, in a preferred embodiment of the invention, it is provided a porous multilayer system (1) comprising at least one bilayer (4) consisting of two porous layers (L₁) (2) and (L₂) (3), wherein porous layer (L₁) (2) and porous layer (L₂) (3) comprise respectively a host material (h₁) and a (total) host material (h_{2,tot}), said (h_{2,tot}) comprising (or consisting of) (a mixture of) (at least) 2 host materials (h₂) and (h₃) (or (h_{2,tot})=(h₂)+(h₃)), wherein the refractive index (n₁) of the host material (h₁) in porous layer (L₁) (2) is different from the refractive index (n_{2,tot}) of the host material (h_{2,tot}) in porous layer (L₂) (3), wherein porous layer (L₁) (2) and porous layer (L₂) (3) further comprise respectively a (initial) pore material (p₁) and a (initial) pore material (p₂), said porous multilayer system (1) having a (overall) (initial) reflectance (Rᵢₙᵢₜᵢₐₗ) with respect to an incident electromagnetic radiation being minimal, and (accordingly) a (overall) (initial) transmittance (Tᵢₙᵢₜᵢₐₗ) with respect to an incident electromagnetic radiation being maximal, said (overall) (initial) reflectance (Rᵢₙᵢₜᵢₐₗ) and said (overall) (initial) transmittance (Tᵢₙᵢₜᵢₐₗ) corresponding to a (initial) state (Sᵢₙᵢₜᵢₐₗ) of the porous multilayer system (1), wherein said porous multilayer system (1) is capable of (reversibly or irreversibly, preferably reversibly) switching (or shifting) from (initial) state (Sᵢₙᵢₜᵢₐₗ) to (final) state (S_{final}), wherein (S_{final}) corresponds to the state wherein the (overall) (final) reflectance (R_{final}) of the porous multilayer system (1) is maximal, and (accordingly) the (overall) (final) transmittance (T_{final}) is minimal.

Even more particularly, in a preferred embodiment of the invention, it is provided a porous multilayer system (1) comprising at least one bilayer (4) consisting of two porous layers (L₁) (2) and (L₂) (3), wherein porous layer (L₁) (2) and porous layer (L₂) (3) comprise respectively a host material (h₁) and a (total) host material (h_{2,tot}), said (h_{2,tot}) comprising (or consisting of) (a mixture of) (at least) 2 host materials (h₂) and (h₃) (or (h_{2,tot})=(h₂)+(h₃)), wherein the refractive index (n₁) of the host material (h₁) in porous layer (L₁) (2) is different from the refractive index (n_{2,tot}) of the host material (h_{2,tot}) in porous layer (L₂) (3), wherein porous layer (L₁) (2) and porous layer (L₂) (3) further comprise respectively a (initial) pore material (p₁) and a (initial) pore material (p₂), said pore material (p₁) and said (initial) pore material (p₂) being air or a (mixture of) inert gas(es), said porous multilayer system (1) having a (overall) (initial) reflectance (R₁) with respect to an incident electromagnetic radiation being comprised between (about) 0% to (about) 25%, more preferably being (about) 0%, and (accordingly) a (overall) (initial) transmittance (T₁) with respect to an incident electromagnetic radiation being comprised between (about) 75% to (about) 100%, more preferably being (about) 100%, said (overall) (initial) reflectance (R₁) and said (overall) (initial) transmittance (T₁) corresponding to a (initial) state (S₁) of the porous multilayer system (1), wherein said porous multilayer system (1) is capable of (reversibly or irreversibly, preferably reversibly) switching (or shifting) from (initial) state (S₁) to (final) state (S₂), wherein (S₂) corresponds to the state wherein the (overall) (final) reflectance (R₂) of the porous multilayer system (1) is comprised between (about) 60% and (about) 100%, more preferably is (about) 100%, and (accordingly) the (overall) (final) transmittance (T₂) is comprised between (about) 0% and (about) 40%, more preferably is (about) 0%.

More preferably, the porous multilayer system according to the invention is further capable of switching (back) from state (S₂) (or mirror state) to state (S₁) (or transparent state) by (substantially complete) removing said composition (C) (7) (other than air or inert gas) from said porous multilayer system (1).

According to the present invention, (substantially all) said composition (C) can be removed from the porous multilayer system by heating the porous multilayer system and evaporating the composition (C), or by evaporating the composition (C) at room (or ambient) temperature.

Even more preferably, the porous multilayer system according to the invention is capable of (reversibly or irreversibly, preferably reversibly) switching from state (S₁) (or transparent state) to state (S₂) (or mirror state) by introducing a composition (C) (7) (other than air or inert gas) into porous layer (L₁) (2) and/or porous layer (L₂) (3), most preferably into the pores (5) of porous layer (L₁) (2) and/or the pores (6) of porous layer (L₂) (3), and/or is capable of switching (back) from state (S₂) (or mirror state) to state (S₁) (or transparent state) by (substantially complete) removing a composition (C) (7) (other than air or inert gas) from porous layer (L₁) (2) and/or porous layer (L₂) (3), most preferably from the pores (5) of porous layer (L₁) (2) and/or the pores (6) of porous layer (L₂) (3).

More preferably, the porous multilayer system according to the invention further comprises a composition (C) (7) (other than air or inert gas) present in any of porous layer (L₁) (2) and/or (L₂) (3), even more preferably present in the pores (5,6) of any of porous layer (L₁) (2) and/or (L₂) (3).

In the context of the present invention, a composition (C) being present in (or introduced into) a porous layer (L₁) refers to the composition (C) being present in substantially the entire pore volume of porous layer (L₁) or the composition (C) being present in a fraction of the pore volume of porous layer (L₁).

Even more preferably, a (suitably selected) composition (C) is adsorbed, absorbed or injected into either one of porous layer (L₁) and/or (L₂) of the porous multilayer system according to the invention.

According to one aspect, composition (C) may be adsorbed or absorbed from ambient environment, when such composition is e.g. is present in vapor phase in the surrounding environment

In another aspect, composition (C) may be actively injected or introduced into either one of porous layer (L₁) and/or (L₂) of the multilayer system.

Even more preferably, the composition (C) is adsorbed, absorbed, injected, or introduced by any other means, into either porous layer (L₁), or (L₂), or into both layers (L₁) and (L₂), of the multilayer material according to the invention.

The porous multilayer system (1) of the invention being in (final) state (S₂) comprises a (liquid) composition (C) (7) (other than air or inert gas) (or in (final) state (S₂) a composition (C) is present in one or more layers of the porous multilayer system (1) of the invention). In other words, said (initial) pore material (p₁) and/or (p₂) being a composition (C) (7), said porous multilayer system (1) is said to be (substantially) “wet” or in a “wet state”, said porous layer (L₁) (2) and/or said porous layer (L₂) (3) are said to be (substantially) “wet”).

In the context of the present invention, the wording “a porous layer (L₁) is (substantially) wet” refers to (all) the pores of porous layer (L₁) being filled with a (liquid) composition (C), or with water.

The porous multilayer system (1) of the invention being in (final) state (S₂) is a porous multilayer system (1) wherein a composition (C) is further introduced into porous layer (L₁) and/or porous layer (L₂), preferably into the pores (5) of porous layer (L₁) and/or the pores (6) of porous layer (L₂).

More particularly, said porous multilayer system, wherein composition (C) is present, is in a (final) state (S₂) (or mirror state) (or is switched from (initial) state (S₁) (or transparent state) to (final) state (S₂) (or mirror state) by the introduction of said composition (C)).

By putting a composition (C) inside the pores of porous layer (L₁) and/or porous layer (L₂) of the porous multilayer system (1) of the invention, the system will switch to a (final) state (S₂) in which the transmittance drops down and the reflectance increases (when compared to initial state (S₁)). In other words, when the composition (other than air or inert gas) fills the pores of porous layer (L₁) and/or porous layer (L₂), the state switches from (initial state) (S₁) (or transparent state) to (final state) (S₂) (or mirror state).

According to the present invention, said composition (C) can further be (substantially) removed from the porous multilayer system by heating the porous multilayer system and evaporating the composition (C), or by evaporating the composition (C) at room (or ambient) temperature.

Alternatively, in the porous multilayer system according to the invention, said (initial) pore material (p₁) or (initial) pore material (p₂) is a composition (C) (7) (other than air or inert gas), said porous multilayer system (1) comprising said composition (C) (7) having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly, preferably reversibly) switching from (initial) state (S₁′) (or transparent state) to (final) state (S₂) (or mirror state) and/or (back) from state (S₂) (or mirror state) to (initial) state (S₁′) (or transparent state) via displacement of a composition (C) (7) (other than air or inert gas) through said porous multilayer system (1), more preferably from the pores (5) of porous layer (L₁) (2) to the pores (6) of porous layer (L₂) (3) or from the pores (6) of porous layer (L₂) (3) to the pores (5) of porous layer (L₁) (2), wherein (the final state) (S₂) corresponds to the state wherein the (overall) (final) reflectance (R₂) of the porous multilayer system (1) comprising said composition (C) (7) is comprised between (about) 60% and (about) 100%, more preferably is (about) 100%, and (accordingly) the (overall) (final) transmittance (T₂) is comprised between (about) 0% and (about) 40%, more preferably is (about) 0%.

The porous multilayer system (1) of the invention being in (initial) state (S₁′) comprises a (liquid) composition (C) (other than air or inert gas) (or in (initial) state (S₁′) a composition (C) is present in the porous multilayer system (1) of the invention).

The (initial) state (S₁′) of the porous multilayer system (1) of the invention is different from the (initial) state (S₁) of the porous multilayer system (1) of the invention as above-described.

More particularly, (initial) pore material (p₁) and (initial) pore material (p₂) are different.

More particularly, in the porous multilayer system (1) of the invention in (initial) state (S₁′), said (initial) pore material (p₁) is a composition (C) (7) (and said (initial) pore material (p₂) is air or a (mixture of) inert gas(es)); or said (initial) pore material (p₂) is a composition (C) (7) (and said (initial) pore material (p₁) is air or a (mixture of) inert gas(es)).

The (final) state (S₂) of the porous multilayer system (1) of the invention is complementary to the (initial) state (S₁′) of the porous multilayer system (1).

Otherwise said, in the porous multilayer system (1) of the invention in (initial) state (S₁′), said porous layer (L₁) (2) is said to be “wet” (and said porous layer (L₂) (3) is said to be “dry”); or said porous layer (L₂) (3) is said to be “wet” (and said porous layer (L₁) (2) is said to be “dry”). Accordingly, in the porous multilayer system (1) of the invention in (final) state (S₂), said porous layer (L₁) (2) is said to be “dry” (and said porous layer (L₂) (3) is said to be “wet”); or said porous layer (L₂) (3) is said to be “dry” (and said porous layer (L₁) (2) is said to be “wet”).

In the porous multilayer system (1) of the invention, the (overall) (initial) reflectance (R₁′) is different from the (overall) (final) reflectance (R₂); and the (overall) (initial) transmittance (T₁′) is different from the (overall) (final) transmittance (T₂).

In the context of the present invention, the wording “a porous multilayer system (1) switching (or shifting) from (initial) state (S₁) (or from (initial) state (S₁′)) to (final) state (S₂)” refers to a porous multilayer system (1) switching (or shifting) from (initial) “transparent” state to (final) “mirror” state.

In the context of the present invention still, the expression “the porous multilayer system is capable of (reversibly or irreversibly, preferably reversibly) switching from state (S₁) (or from state (S₁′)) to state (S₂) and/or from state (S₂) to state (S₁)” is meant to express the fact that the porous multilayer system of the invention may quickly or gradually (reversibly or irreversibly, preferably reversibly) pass from state (S₁) to state (S₂) and/or from state (S₂) to state (S₁).

In the context of the present invention, (initial) state (S₁) or (initial) state (S₁′) of the porous multilayer system (referred to herein as transparent state) corresponds to the state wherein the transmittance (T) of the porous multilayer system is maximal (and accordingly, the reflectance (R) of the porous multilayer system is minimal) as above-described. In a preferred aspect, state (S₁) or state (S₁′) of the porous multilayer system corresponds to the state wherein the multilayer system behaves like a transparent material. By “transparent”, it is meant herein that an incident electromagnetic radiation may pass (or passes) through the porous multilayer system without being substantially reflected.

In the context of the present invention, (final) state (S₂) of the porous multilayer system (referred to herein as (Bragg) mirror state) corresponds to the state wherein the reflectance (R) of the porous multilayer system is maximal (and accordingly, the transmittance (T) of the porous multilayer system is minimal) as above-described. In a preferred aspect, state (S₂) of the porous multilayer system corresponds to the state wherein the multilayer system behaves like a so-called Bragg reflector (well known to those skilled in the art of refractive material). By a “Bragg reflector”, it is meant herein that an incident electromagnetic radiation may substantially not pass through the porous multilayer system without being reflected.

In the context of the present invention, the term pore material (p) is meant to designate the material/compound which is contained into the corresponding pore. Suitable pore material for use in the context of the present invention will be easily identified by the skilled person in the light of the present description.

More preferably, in the porous multilayer system according to the invention, said (initial) pore material (p₁) is a composition (C) (7) (other than air or inert gas) and said (initial) pore material (p₂) is air or inert gas, said porous multilayer system being capable of (reversibly) switching from state (S₁′) (or transparent state) to state (S₂) (or mirror state) via (substantially) complete displacement of said composition (C) (7) (other than air or inert gas) from the pores (5) of porous layer (L₁) (2) to the pores (6) of porous layer (L₂) (3), and said porous multilayer system being capable of switching (back) from state (S₂) (or mirror state) to state (S₁′) (or transparent state) via (substantially) complete displacement of said composition (C) (7) (other than air or inert gas) from the pores (6) of porous layer (L₂) (3) to the pores (5) of porous layer (L₁) (2).

More particularly, in (S₁′) said (initial) pore material (p₁) is a composition (C) (7) (other than air or inert gas) (or L₁ is “wet”) and said (initial) pore material (p₂) is air or inert gas (or L₂ is “dry”), and accordingly, in (S₂) (final) pore material (p₁) is air or inert gas (or L₁ is “dry”) and said (final) pore material (p₂) is composition (C) (7) (other than air or inert gas) (or L₂ is “wet”).

More preferably, in the porous multilayer system according to the invention, said (initial) pore material (p₁) is air or inert gas and (initial) pore material (p₂) is a composition (C) (7) (other than air or inert gas), said porous multilayer system being capable of (reversibly) switching from state (S₁′) (or transparent state) to state (S₂) (or mirror state) via (substantially) complete displacement of said composition (C) (7) (other than air or inert gas) from the pores (6) of porous layer (L₂) (3) to the pores (5) of porous layer (L₁) (2), and said porous multilayer system being capable of switching (back) from state (S₂) (or mirror state) to state (S₁′) (or transparent state) via (substantially) complete displacement of said composition (C) (7) (other than air or inert gas) from the pores (5) of porous layer (L₁) (2) to the pores (6) of porous layer (L₂) (3).

More particularly, in (S₁′) said (initial) pore material (p₁) is air or inert gas (or L₁ is “dry”) and said (initial) pore material (p₂) is a composition (C) (7) (other than air or inert gas) (or L₂ is “wet”), and accordingly, in (S₂) (final) pore material (p₁) is composition (C) (7) (other than air or inert gas) (or L₁ is “wet”) and said (final) pore material (p₂) is air or inert gas (or L₂ is “dry”).

In the context of the present invention, (substantially) complete displacement of said composition (C) refers to displacement of (substantially) the (whole) entirety of composition (C).

In the context of the present invention, the expression “displacement of a composition (C) through the porous multilayer system” is meant to refer to any of migration, diffusion, transfer, adsorption of the composition (C) through the porous multilayer system.

In a preferred aspect of the invention, in the porous multilayer system according to the invention, the displacement of composition (C) through the porous multilayer is operated without any external intervention. According to this preferred aspect, the displacement of composition (C) through the porous multilayer occurs by natural diffusion, adsorption, absorption, transit or migration (e.g. by capillary effect).

Without wishing to be bound by theory, and according to a preferred execution of the porous multilayer system according to the invention wherein the average pore diameter in porous layer (L₂) is larger than the average pore diameter in porous layer (L₁), the displacement of composition (C) through the porous multilayer (by e.g. natural diffusion), and in particular from porous layer (L₁) to porous layer (L₂) is believed to be promoted owing to a “suction” or “pumping” effect.

More preferably, the displacement of composition (C) through the porous multilayer is induced by capillary effect or capillary attraction (depending on pore size), or by hydrophilic/hydrophobic effects (pore surface functionalization).

In the context of the present invention, capillary attraction of composition (C) is due to the difference in pore sizes between adjacent (metal oxide) layers (i.e. smaller pores in porous layer (L₁) and larger pores in porous layer (L₂)).

Alternatively and according to another preferred aspect, in the porous multilayer system according to the invention, the displacement of composition (C) through the porous multilayer is induced by an external source.

More preferably, said external source is selected from the group consisting of electrical sources, magnetic sources, electromagnetic sources, mechanical sources, chemical sources, thermal sources, and combinations thereof.

Even more preferably, said external source is selected from the group consisting of electrical sources, magnetic sources, electromagnetic sources, and combinations thereof.

Most preferably, the source is selected to be an electrical source.

Preferably, in the porous multilayer system according to the invention, the at least one bilayer consisting of two porous layers (L₁) and (L₂) are formed by sol-gel technique, more preferably using spin-coating technique.

Preferably, the porous multilayer system according to the invention is coated onto a substrate. According to this one execution, the porous multilayer system according to the invention advantageously takes the form of a porous coating.

More preferably, the substrate is made from a material selected from the group consisting of transparent, translucent and opaque materials. Even more preferably, the substrate is transparent and is preferably made from a material which is selected from glass, conductive glass, quartz, silicon wafer, or plastic; more preferably from glass or plastic. Even more preferably, the substrate is made from glass.

Preferably, in a device formed by a porous multilayer system according to the invention coated onto a substrate, the porous multilayer system of the invention is coated onto the substrate in such a way that the external uncoated layer of the at least one bilayer corresponds to porous layer (L₁). More precisely, in a device formed by a porous multilayer system according to the invention coated onto a substrate, it is preferred that the uncoated layer of the at least one bilayer which is potentially in contact with external environment or atmosphere, corresponds to porous layer (L₁).

Preferably, in the porous multilayer system according to the invention, (n₁)<(n₂).

More particularly, the refractive index (n₁) of the host material (h₁) in porous layer (L₁) (2) is lower when compared to refractive index (n₂) of the host material (h₂) in porous layer (L₂) (3).

More preferably, in the porous multilayer system according to the invention, (n₁)<(n_{2,tot}).

More particularly, the refractive index (n₁) of the host material (h₁) in porous layer (L₁) (2) is lower when compared to refractive index (n_{2,tot}) of (the mixture of) the (at least) 2 host materials (h₂) and (h₃) (or (total) host material (h_{i,tot})) in porous layer (L₂) (3).

Preferably, in the porous multilayer system according to the invention, porous layer (L₁) (2) is hydrophobic and/or porous layer (L₂) (3) is hydrophilic.

More preferably, in the porous multilayer system according to the invention, the porous layer (L₁) (2) is hydrophobic and porous layer (L₂) (3) is hydrophilic.

More particularly, the displacement of the composition from porous layer (L₁) to porous layer (L₂) can be achieved by means of an external source (e.g. by electro-wetting), after having tuned (L₁) to be (more) hydrophobic (when compared to (L₂)).

More preferably, in the porous multilayer system (1) of the invention, porous layer (L₁) (2) is (substantially) “dry”, and porous layer (L₂) (3) is (substantially) “wet” in (final) state (S₂), by tuning porous layer (L₁) (2) to be (more) hydrophobic (when compared to porous layer (L₂) (3).

For example, a hydrophobic silica layer can be obtained by one pot co-condensation of methyltriethoxysilane and tetraethyl orthosilicate to introduce pendant organic group into the pore of silica layer at adequate level, or by grafting hydrophobic molecules into the porous silica layer. Water molecules are kept outside of the silica layer due to the surface chemistry affinity which reduces their presence inside the structure channels (of the silica layer).

Preferably, in the porous multilayer system according to the invention, the composition (C) (7) (other than air or inert gas) is selected from the group consisting of liquid compositions, vapor compositions, and combinations thereof.

Suitable composition (C) for use in the porous multilayer system according to the invention may also be easily identified by those skilled in the art in the light of the present description. Typical examples of compositions (C) for use herein include, but are not limited to, liquid compositions, gel compositions, pasty compositions, gaseous compositions, and combinations thereof.

Preferably, composition (C) is selected from the group consisting of liquid compositions, gaseous compositions, and combinations thereof.

More preferably, in the porous multilayer system according to the invention, the composition (C) (7) is selected from liquid compositions, preferably from aqueous compositions, more preferably said composition is water.

However, other liquid compositions such as ionic compositions, liquid metal compositions, organic solvents, hydroalcoholic solutions, alcoholic solutions, and the like, may be used in the context of the present invention.

Preferably, in the porous multilayer system according to the invention, the incident electromagnetic radiation ranges from long waves (or radio waves) radiations to gamma rays, preferably from microwaves to X-rays radiations, more preferably from infrared to ultraviolet radiations, most preferably said incident electromagnetic radiation is visible light.

Porous layers (L₁) and (L₂) for use in the present invention may comprise any suitable (host) material that is known in the art and that is conventionally used for the manufacture of multilayer systems and in particular multilayer systems used for interference filters, optical reflectors, and the like.

Suitable (host) material for the manufacture of porous layers for use herein may be easily identified by those skilled in the art. Typical examples of (host) material include, but are not limited to, silicon, titanium, aluminum, gallium, zirconium, niobium, indium, tin, and mixtures thereof. Preferably, (host) material for the manufacture of porous layers is selected from the group consisting of silicon, titanium, aluminum, and mixtures thereof. More preferably, (host) material for the manufacture of porous layers is selected from the group consisting of silicon oxide, titanium oxide, aluminum oxide, and combinations thereof.

Preferably, in the porous multilayer system according to the invention, (the host material (h₁) in) porous layer (L₁) (2) comprises (or consists of) silicon, more preferably comprises silicon oxide, even more preferably (the host material (h₁) in) porous layer (L₁) (2) consists of silicon oxide.

Preferably, in the porous multilayer system according to the invention, (the host material (h₂) in) porous layer (L₂) (3) comprises (or consists of) titanium, more preferably comprises titanium oxide, even more preferably (the host material (h₂) in) porous layer (L₂) (3) consists of titanium oxide.

Preferably, in the porous multilayer system according to the invention, (the host material (h₂) in) porous layer (L₂) further comprises aluminum, more preferably comprises aluminum oxide.

Preferably, in the porous multilayer system according to the invention, (the host material (h₁) in) porous layer (L₁) (2) comprises (or consists of) silicon oxide, and (the host material (h₂) in) porous layer (L₂) (3) comprises (or consists of) titanium oxide.

More preferably, in the porous multilayer system according to the invention, (the host material (h₁) in) porous layer (L₁) (2) comprises (or consists of) silicon oxide, (the host material (h₂) in) porous layer (L₂) (3) comprises (or consists of) titanium oxide, and composition (C) (7) is water.

Alternatively, in the porous multilayer system in a preferred embodiment of the invention, (the host material (h_{2,tot}) in) porous layer (L₂) (3) comprises titanium (host material (h₂)) and aluminum (host material (h₃)), even more preferably comprises titanium oxide (host material (h₂)) and aluminum oxide (host material (h₃)), most preferably (the host material (h_{2,tot}) in) porous layer (L₂) (3) consists of titanium oxide (host material (h₂)) and aluminum oxide (host material (h₃)).

More particularly, (the host material (h₁) in) porous layer (L₁) (2) comprises (or consists of) silicon oxide, (the host material (h_{2,tot}) in) porous layer (L₂) (3) comprises (or consists of) titanium oxide (host material (h₂)) and aluminum oxide (host material (h₃)), and composition (C) (7) is water.

Porous layers for use herein may be formed using any suitable technique, as are well known to those skilled in the art. Preferably, in the porous multilayer system according to the invention, the porous layers (L₁) and (L₂) are formed by sol-gel technique, more preferably using spin-coating technique. Other suitable techniques for the manufacture of porous layers may be easily identified by those skilled in the art.

In the context of the present invention, the method of manufacturing porous layers for use herein may preferably include the step of using suitably selected porogen agents. Suitable porogen agents for use herein may be easily identified by the skilled person.

Preferably, in the porous multilayer system according to the invention, the (initial) pore volume fraction (fₚₒᵣₑ₁) of porous layer (L₁) (2) and the (initial) pore volume fraction (fₚₒᵣₑ₂) of porous layer (L₂) (3) are such that said (initial) (fₚₒᵣₑ₁) and said (initial) (fₚₒᵣₑ₂) satisfy the following equation:

$${f}_{pore 2} = {f}_{pore 1} \frac{β ( {u}_{1}^{p} ) - β ( {u}_{1}^{h} )}{β ( {u}_{2}^{p} ) - β ( {u}_{2}^{h} )} + \frac{β ( {u}_{1}^{h} ) - β ( {u}_{2}^{h} )}{β ( {u}_{2}^{p} ) - β ( {u}_{2}^{h} )} \qquad ( 1 )$$

wherein

$$β ( {u}_{i}^{p} ) = \frac{1 - {u}_{i}^{p}}{{u}_{i}^{p} ( 1 - {Γ}_{i} ) + 1} ;$$

$$β ( {u}_{i}^{h} ) = \frac{1 - {u}_{i}^{h}}{{u}_{i}^{h} ( 1 - {Γ}_{i} ) + 1} ;$$

$${u}_{i}^{p} = \frac{\overline{ɛ}}{{ɛ}_{i}^{p}} ;$$

$${u}_{i}^{h} = \frac{\overline{ɛ}}{{ɛ}_{i}^{h}} ;$$

wherein i=1 or 2;
wherein ε̅ is the effective dielectric constant (or transparency effective dielectric constant) in (initial) state (S₁) or in (initial) state (S₁′); wherein ε̅= n̅², n̅ being the effective refractive index (or transparency effective refractive index) in (initial) state (S₁) or in (initial) state (S₁′); wherein εᵢ^{p}=(nᵢ^{p})², εᵢ^{p} being the dielectric constant of pore material (p₁) in porous layer (Lᵢ); wherein εᵢ^{h}=(nᵢ^{h})², εᵢ^{h} being the dielectric constant of host material (hᵢ) in porous layer (Lᵢ); and wherein (Γᵢ) is the depolarization factor of porous layer (Lᵢ).

In the context of the present invention, ε̅ is meant to refer to the dielectric constant which is common to both porous layer (L₁) and porous layer (L₂) of the porous multilayer system in the transparency state (S₁) or (S₁′).

In the context of the present invention still, n̅ is meant to refer to the refractive index which is common to both porous layer (L₁) and porous layer (L₂) of the porous multilayer system in the transparency state (S₁) or (S₁′).

In the context of the present invention, the above-mentioned equation (1) is meant to characterize formally perfect transparency state (S₁) or (S₁′) of the porous multilayer system, as above-described.

In that context, parameters ε̅ and n̅, which correspond respectively to the transparency effective dielectric constant and the transparency effective refractive index (of the porous multilayer system), are calculated/deduced based on the Bruggeman's effective medium theory. Such calculation is well within the capabilities of the skilled person.

Similarly, the calculation or determination of parameters such as εᵢ^{p}, being the dielectric constant of pore material (pᵢ) in porous layer (Lᵢ), and εᵢ^{h}, being the dielectric constant of host material (hᵢ) in porous layer (Lᵢ), will be easily performed by those skilled in the art.

When the porous layer (Lᵢ) of the invention comprises a (total) host material (h_{i,tot}), said (h_{i,tot}) comprising (or consisting of) (a mixture of) at least 2 host materials (hᵢ) and (hⱼ), the (total) dielectric constant (or (total) refractive index n_{i,tot}) of (the mixture of) the at least 2 host materials (hᵢ) and (hⱼ) (or (total) host material (h_{i,tot})) is calculated using the Bruggeman's effective medium theory. Such calculation is well within the capabilities of the skilled person.

As regard to parameter (Γᵢ) which represents the depolarization factor of porous layer (Lᵢ), its calculation will again be easily apparent to the skilled person. The calculation of (Γᵢ) will take into account the geometry of the pore material (pᵢ) in porous layer (Lᵢ).

Preferably, in the porous multilayer system according to the invention, the pores present in porous layer (L₁) and/or porous layer (L₂) have a substantially spherical geometry.

According to a preferred aspect of the porous multilayer system according to the invention, said (initial) pore material (p₁) is air and said (initial) pore material (p₂) is air, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) having a (overall) (initial) reflectance (R₁) with respect to an incident electromagnetic radiation being comprised between (about) 0% to (about) 25%, more preferably being (about) 0%, and (accordingly) a (overall) (initial) transmittance (T₁) with respect to an incident electromagnetic radiation being comprised between (about) 75% to (about) 100%, more preferably being (about) 100%, said (overall) (initial) reflectance (R₁) and said (overall) (initial) transmittance (T₁) corresponding to a (initial) state (S₁) of the porous multilayer system (1), said porous multilayer system (1) is capable of (reversibly or irreversibly, preferably reversibly) switching (or shifting) from (initial) state (S₁) (or transparent state) to (final) state (S₂) (or mirror state) by introducing a composition (C) (7) (other than air or inert gas) into said porous multilayer system (1), wherein (the final state) (S₂) corresponds to the state wherein the (overall) (final) reflectance (R₂) of the porous multilayer system (1) comprising said composition (C) (7) is comprised between (about) 60% and (about) 100%, more preferably is (about) 100%, and (accordingly) the (overall) (final) transmittance (T₂) is comprised between (about) 0% and (about) 40%, more preferably is (about) 0%, and the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial)(fₚₒᵣₑ₂) satisfy the following equation:

fₚₒᵣₑ₂=0.424×fₚₒᵣₑ₁+0.560 (2)

More particularly, in (S₁) said (initial) pore material (p₁) is air (or L₁ is “dry”) and said (initial) pore material (p₂) is air (or L₂ is “dry”). Accordingly, in (S₂), (final) pore material (p₁) is air (or L₁ is “dry”) and (final) pore material (p₂) is composition (C) (or L₂ is “wet”); or (final) pore material (p₁) is composition (C) (or L₁ is “wet”) and (final) pore material (p₂) is air (or L₂ is “dry”); or (final) pore material (p₁) is composition (C) (or L₁ is “wet”) and (final) pore material (p₂) is composition (C) (or L₂ is “wet”).

According to another preferred aspect of the porous multilayer system according to the invention, said (initial) pore material (p₁) is air and said (initial) pore material (p₂) is air, (the host material (h₁) in) porous layer (L₁) (2) comprises (or consists of) silicon oxide and (the host material (h_{2,tot}) in) porous layer (L₂) (3) comprises (or consists of) titanium oxide (h₂) and aluminum oxide (h₃), said porous multilayer system (1) having a (overall) (initial) reflectance (R₁) with respect to an incident electromagnetic radiation being comprised between (about) 0% to (about) 25%, more preferably being (about) 0%, and (accordingly) a (overall) (initial) transmittance (T₁) with respect to an incident electromagnetic radiation being comprised between (about) 75% to (about) 100%, more preferably being (about) 100%, said (overall) (initial) reflectance (R₁) and said (overall) (initial) transmittance (T₁) corresponding to a (initial) state (S₁) of the porous multilayer system (1), said porous multilayer system (1) is capable of (reversibly or irreversibly, preferably reversibly) switching (or shifting) from (initial) state (S₁) (or transparent state) to (final) state (S₂) (or mirror state) by introducing a composition (C) (7) (other than air or inert gas) into said porous multilayer system (1), wherein (the final state) (S₂) corresponds to the state wherein the (overall) (final) reflectance (R₂) of the porous multilayer system (1) comprising said composition (C) (7) is comprised between (about) 60% and (about) 100%, more preferably is (about) 100%, and (accordingly) the (overall) (final) transmittance (T₂) is comprised between (about) 0% and (about) 40%, more preferably is (about) 0%, and the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.518×fₚₒᵣₑ₁+0.472 (2′)

Preferably, (the host material (h_{2,tot}) in) porous layer (L₂) (3) comprises (or consists of) 50% TiO₂-50% Al₂O₃.

More particularly, in (S₁) said (initial) pore material (p₁) is air (or L₁ is “dry”) and said (initial) pore material (p₂) is air (or L₂ is “dry”). Accordingly, in (S₂), (final) pore material (p₁) is air (or L₁ is “dry”) and (final) pore material (p₂) is composition (C) (or L₂ is “wet”); or (final) pore material (p₁) is composition (C) (or L₁ is “wet”) and (final) pore material (p₂) is air (or L₂ is “dry”); or (final) pore material (p₁) is composition (C) (or L₁ is “wet”) and (final) pore material (p₂) is composition (C) (or L₂ is “wet”).

According to another preferred aspect of the porous multilayer system according to the invention, said (initial) pore material (p₁) is water and said (initial) pore material (p₂) is air, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly, preferably reversibly) switching from state (S₁′) (or transparent state) to (final) state (S₂) (or mirror state) and/or (back) from state (S₂) (or mirror state) to (initial) state (S₁′) (or transparent state) via displacement of said water through said porous multilayer system (1), more preferably from the pores (5) of porous layer (L₁) (2) to the pores (6) of porous layer (L₂) (3) or (back) from the pores (6) of porous layer (L₂) (3) to the pores (5) of porous layer (L₁) (2), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.164×fₚₒᵣₑ₁+0.572 (3)

More particularly, in (S₁′) said (initial) pore material (p₁) is water (or L₁ is “wet”) and said (initial) pore material (p₂) is air (or L₂ is “dry”), and accordingly, in (S₂), (final) pore material (p₁) is air (or L₁ is “dry”) and (final) pore material (p₂) is water (or L₂ is “wet”).

More particularly, in the porous multilayer system according to the invention, said (initial) pore material (p₁) is water and said (initial) pore material (p₂) is air, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly) switching from state (S₁′) (or transparent state) to (final) state (S₂) (or mirror state) via (substantially) complete displacement of said water through said porous multilayer system (1), more preferably from the pores (5) of porous layer (L₁) (2) to the pores (6) of porous layer (L₂) (3), and said porous multilayer system being capable of switching (back) from (final) state (S₂) (or mirror state) to (initial) state (S₁′) (or transparent state) via (substantially) complete displacement of said water through said porous multilayer system (1), more preferably (back) from the pores (6) of porous layer (L₂) (3) to the pores (5) of porous layer (L₁) (2), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.164×fₚₒᵣₑ₁+0.572 (3)

According to another preferred aspect of the porous multilayer system according to the invention, said (initial) pore material (p₁) is water and said (initial) pore material (p₂) is air, (the host material (h₁) in) porous layer (L₁) (2) comprises (or consists of) silicon oxide and (the host material (h_{2,tot}) in) porous layer (L₂) (3) comprises (or consists of) titanium oxide (h₂) and aluminum oxide (h₃), said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly, preferably reversibly) switching from state (S₁′) (or transparent state) to (final) state (S₂) (or mirror state) and/or (back) from state (S₂) (or mirror state) to (initial) state (S₁′) (or transparent state) via displacement of said water through said porous multilayer system (1), more preferably from the pores (5) of porous layer (L₁) (2) to the pores (6) of porous layer (L₂) (3) or (back) from the pores (6) of porous layer (L₂) (3) to the pores (5) of porous layer (L₁) (2), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial)) (fₚₒᵣₑ₁) and (initial)) (fₚₒᵣₑ₂) satisfy the following equation:

fₚₒᵣₑ₂=0.164×fₚₒᵣₑ₁+0.481 (3′)

Preferably, (the host material (h_{2,tot}) in) porous layer (L₂) (3) comprises (or consists of) 50% TiO₂-50% Al₂O₃.

More particularly, in (S₁′) said (initial) pore material (p₁) is water (or L₁ is “wet”) and said (initial) pore material (p₂) is air (or L₂ is “dry”), and accordingly, in (S₂), (final) pore material (p₁) is air (or L₁ is “dry”) and (final) pore material (p₂) is water (or L₂ is “wet”).

More particularly, in the porous multilayer system according to the invention, said (initial) pore material (p₁) is water and said (initial) pore material (p₂) is air, (the host material (h₁) in) porous layer (L₁) (2) comprises (or consists of) silicon oxide and (the host material (h_{2,tot}) in) porous layer (L₂) (3) comprises (or consists of) titanium oxide (h₂) and aluminum oxide (h₃), said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly) switching from state (S₁′) (or transparent state) to (final) state (S₂) (or mirror state) via (substantially) complete displacement of said water through said porous multilayer system (1), more preferably from the pores (5) of porous layer (L₁) (2) to the pores (6) of porous layer (L₂) (3), and said porous multilayer system being capable of switching (back) from (final) state (S₂) (or mirror state) to (initial) state (S₁′) (or transparent state) via (substantially) complete displacement of said water through said porous multilayer system (1), more preferably (back) from the pores (6) of porous layer (L₂) (3) to the pores (5) of porous layer (L₁) (2), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.164×fₚₒᵣₑ₁+0.481 (3′)

Preferably, (the host material (h_{2,tot}) in) porous layer (L₂) (3) comprises (or consists of) 50% TiO₂-50% Al₂O₃.

According to yet another preferred aspect of the porous multilayer system according to the invention, said (initial) pore material (p₁) is air and (initial) pore material (p₂) is water, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly, preferably reversibly) switching from state (S₁′) (or transparent state) to (final) state (S₂) (or mirror state) and/or (back) from state (S₂) (or mirror state) to (initial) state (S₁′) (or transparent state) via displacement of said water through said porous multilayer system (1), more preferably from the pores (6) of porous layer (L₂) (3) to the pores (5) of porous layer (L₁) (2) or (back) from the pores (5) of porous layer (L₁) (2) to the pores (6) of porous layer (L₂) (3), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial)) (fₚₒᵣₑ₂) satisfy the following equation:

fₚₒᵣₑ₂=0.703×fₚₒᵣₑ₁+0.714 (4)

More particularly, in (S₁′) said (initial) pore material (p₁) is air (or L₁ is “dry”) and said (initial) pore material (p₂) is water (or L₂ is “wet”), and accordingly, in (S₂), (final) pore material (p₁) is water (or L₁ is “wet”) and (final) pore material (p₂) is air (or L₂ is “dry”).

More particularly, in the porous multilayer system according to the invention, said (initial) pore material (p₁) is air and (initial) pore material (p₂) is water, (the host material (h₁) in) porous layer (L₁) (2) comprises (or consists of) silicon oxide and (the host material (h₂) in) porous layer (L₂) (3) comprises (or consists of) titanium oxide, said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly, preferably reversibly) switching from state (S₁′) (or transparent state) to (final) state (S₂) (or mirror state) via (substantially) complete displacement of said water through said porous multilayer system (1), more preferably from the pores (6) of porous layer (L₂) (3) to the pores (5) of porous layer (L₁) (2), and said porous multilayer system being capable of switching (back) from state (S₂) (or mirror state) to state (S₁′) (or transparent state) via (substantially) complete displacement of said water through said porous multilayer system (1), more preferably (back) from the pores (5) of porous layer (L₁) (2) to the pores (6) of porous layer (L₂) (3), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (1₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.702×fₚₒᵣₑ₁+0.714 (4)

According to yet another preferred aspect of the porous multilayer system according to the invention, said (initial) pore material (p₁) is air and (initial) pore material (p₂) is water, (the host material (h₁) in) porous layer (L₁) (2) comprises (or consists of) silicon oxide and (the host material (h_{2,tot}) in) porous layer (L₂) (3) comprises (or consists of) titanium oxide (h₂) and aluminum oxide (h₃), said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly, preferably reversibly) switching from state (S₁′) (or transparent state) to (final) state (S₂) (or mirror state) and/or (back) from state (S₂) (or mirror state) to (initial) state (S₁′) (or transparent state) via displacement of said water through said porous multilayer system (1), more preferably from the pores (6) of porous layer (L₂) (3) to the pores (5) of porous layer (L₁) (2) or (back) from the pores (5) of porous layer (L₁) (2) to the pores (6) of porous layer (L₂) (3), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial) (fₚₒᵣₑ₂) satisfy the following equation:

fₚₒᵣₑ₂=0.934×fₚₒᵣₑ₁+0.694 (4′)

Preferably, (the host material (h_{2,tot}) in) porous layer (L₂) (3) comprises (or consists of) 50% TiO₂-50% Al₂O₃.

More particularly, in (S₁′) said (initial) pore material (p₁) is air (or L₁ is “dry”) and said (initial) pore material (p₂) is water (or L₂ is “wet”), and accordingly, in (S₂), (final) pore material (p₁) is water (or L₁ is “wet”) and (final) pore material (p₂) is air (or L₂ is “dry”).

More particularly, in the porous multilayer system according to the invention, said (initial) pore material (p₁) is air and (initial) pore material (p₂) is water, (the host material (h₁) in) porous layer (L₁) (2) comprises (or consists of) silicon oxide and (the host material (h_{2,tot}) in) porous layer (L₂) (3) comprises (or consists of) titanium oxide (h₂) and aluminum oxide (h₃), said porous multilayer system (1) comprising said water having a (overall) (initial) reflectance (R₁′) with respect to an incident electromagnetic radiation being comprised between (about) 0% to (about) 25%, more preferably being (about) 0%, and (accordingly) a (overall) (initial) transmittance (T₁′) with respect to an incident electromagnetic radiation being comprised between (about) 75% to (about) 100%, more preferably being (about) 100%, said (overall) (initial) reflectance (R₁′) and said (overall) (initial) transmittance (T₁′) corresponding to a (initial) state (S₁′) of the porous multilayer system (1), said porous multilayer system being capable of (reversibly or irreversibly, preferably reversibly) switching from state (S₁′) (or transparent state) to (final) state (S₂) (or mirror state) via (substantially) complete displacement of said water through said porous multilayer system (1), more preferably from the pores (6) of porous layer (L₂) (3) to the pores (5) of porous layer (L₁) (2), and said porous multilayer system being capable of switching (back) from state (S₂) (or mirror state) to state (S₁′) (or transparent state) via (substantially) complete displacement of said water through said porous multilayer system (1), more preferably (back) from the pores (5) of porous layer (L₁) (2) to the pores (6) of porous layer (L₂) (3), wherein (the final state) (S₂) corresponds to the state wherein the (overall) (final) reflectance (R₂) of the porous multilayer system (1) comprising said water is comprised between (about) 60% and (about) 100%, more preferably is (about) 100%, and (accordingly) the (overall) (final) transmittance (T₂) is comprised between (about) 0% and (about) 40%, more preferably is (about) 0%, the (initial) pore volume fraction (fₚₒᵣₑ₁) of porous layer (L₁) (2) and the (initial) pore volume fraction (fₚₒᵣₑ₂) of porous layer (L₂) (3) are such that (initial) (fₚₒᵣₑ₁) and (initial)(fₚₒᵣₑ₂) satisfy the following equation:

fₚₒᵣₑ₂=0.934×fₚₒᵣₑ₁+0.694 (4′)

Preferably, (the host material (h_{2,tot}) in) porous layer (L₂) (3) comprises (or consists of) 50% TiO₂-50% Al₂O₃.

Preferably, in the porous multilayer system according to the invention, porous layers (L₁) and (L₂) have respectively a thickness (d₁) and (d₂), and (d₁) and (d₂) are selected such as to satisfy the following equation:

λ_{B}=2×ñ×(d₁+d₂) (5)

wherein
λ_{B} is the wavelength at which the porous multilayer system is in state (S₂); and

$$\tilde{n} = \frac{{d}_{1}}{{d}_{1} + {d}_{2}} {\overline{n}}_{1} + \frac{{d}_{2}}{{d}_{1} + {d}_{2}} {\overline{n}}_{2} \qquad ( 6 )$$

wherein ñ₁ and ñ₂ are the effective refractive indexes of respectively layer (L₁) and layer (L₂) (calculated according to the Bruggeman's effective medium theory).

In the context of the present invention, determination of parameters λ_{B}, n̅₁ and n̅₂, based on the Bruggeman's effective medium theory, is well within the capabilities of those skilled in the art.

Preferably, in the porous multilayer system according to the invention, the thickness of porous layer (L₁) is comprised between (about) 80 nm and (about) 140 nm, more preferably between (about) 90 nm and (about) 120 nm, even more preferably between (about) 90 nm and (about) 110 nm, most preferably the thickness of porous layer (L₁) is of (about) 100 nm.

Preferably, in the porous multilayer system according to the invention, the thickness of porous layer (L₂) is comprised between (about) 60 nm and (about) 110 nm, more preferably between (about) 70 nm and (about) 100 nm, even more preferably between (about) 70 nm and (about) 90 nm, most preferably the thickness of porous layer (L₂) is of (about) 80 nm.

Preferably, in the porous multilayer system according to the invention, porous layer (L₁) and porous layer (L₂) are selected from the group consisting of microporous layers, mesoporous layers, macroporous layers, and combinations thereof.

In the context of the present invention, by “microporous” layer, it is meant herein a porous layer wherein the average pore diameter is below (about) 4 nm. By “mesoporous” layer, it is meant herein a porous layer wherein the average pore diameter is comprised between (about) 4 and (about) 50 nm. By “macroporous” layer, it is meant herein a porous layer wherein the average pore diameter is above (about) 50 nm.

More preferably, in the porous multilayer system according to the invention, porous layer (L₁) is selected from microporous and mesoporous layers and porous layer (L₂) is selected from the group consisting of mesoporous layers and macroporous layers.

Preferably, in the porous multilayer system according to the invention, the average pore diameter in porous layer (L₂) is larger than the average pore diameter in porous layer (L₁).

Preferably, in the porous multilayer system according to the invention, the average pore diameter in porous layer (L₁) is below (about) 50 nm, preferably below (about) 25 nm, more preferably below (about) 10 nm, even more preferably below (about) 4 nm. Preferably still, the average pore diameter in porous layer (L₁) is comprised between (about) 0.1 nm and (about) 25 nm, more preferably between (about) 0.5 nm and (about) 10 nm, even more preferably between (about) 1 nm and (about) 4 nm.

Preferably, in the porous multilayer system according to the invention, the average pore diameter in porous layer (L₂) is above (about) 4 nm, preferably above (about) 10 nm, more preferably above (about) 25 nm, even more preferably above (about) 50 nm. Preferably still, the average pore diameter in porous layer (L₂) is comprised between (about) 4 nm and (about) 100 nm, more preferably between (about) 5 nm and (about) 50 nm, even more preferably between (about) 10 nm and (about) 25 nm.

Preferably, in the porous multilayer system according to the invention, the accessible porosity of porous layer (L₁) and/or porous layer (L₂) is above (about) 20%, preferably above (about) 25%, more preferably above (about)30%, even more preferably above (about) 35%, yet more preferably above (about) 40%, most preferably above (about) 45%.

In the context of the present invention, the term “accessible porosity” is meant to refer to the percentage of pores contained in the porous layer which are accessible to a composition (C), in particular accessible to a composition (C) which is about to be absorbed, adsorbed or injected into the porous layer.

According to a preferred aspect, in the porous multilayer system according to the invention, the pores which are present in porous layer (L₁) and/or porous layer (L₂) have a certain degree of interconnection. Preferably, the pores which are present in porous layer (L₁) and/or porous layer (L₂) have a degree of interconnection which is above (about) 50%, preferably above (about) 70%, more preferably above (about) 80%, even more preferably above (about) 90%, yet more preferably above (about) 95%. Most preferably, the pores which are present in porous layer (L₁) and/or porous layer (L₂) have a degree of interconnection which is (about) 100%.

According to another preferred aspect, in the porous multilayer system according to the invention, the pores present in porous layer (L₁) have a certain degree of interconnection with the pores present in porous layer (L₂), in particular at the interface between the two porous layers. Preferably, the pores which are present in porous layer (L₁) have a degree of interconnection with the pores present in porous layer (L₂) which is above (about) 50%, preferably above (about) 70%, more preferably above (about) 80%, even more preferably above (about) 90%, yet more preferably above (about) 95%. Most preferably, the pores which are present in porous layer (L₁) have a degree of interconnection with the pores present in porous layer (L₂) which is (about) 100%.

Without being bound by theory, it is believed that the higher the accessible porosity and/or the degree of interconnection of the pores, the more efficient is the migration, diffusion, transfer or adsorption of the composition (C) through the porous multilayer system.

Preferably, the porous multilayer system according to the invention, comprises any of 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 bilayers (4) (each bilayer) consisting of two porous layers (L₁) (2) and (L₂) (3), more preferably said porous multilayer comprises less than 30, even more preferably less than 20, yet more preferably less than 10, most preferably less than 5 of said bilayers (4).

More preferably, the porous multilayer system according to the invention, comprises any of 2, 3, 4, 5, 6, 7, 8, 9, 10, 11, 12, 13, 14, 15, 16, 17, 18, 19, 20, 21, 22, 23, 24, 25, 26, 27, 28, 29 or 30 bilayers (4) consisting of two porous layers (L₁) (2) and (L₂) (3), even more preferably said porous multilayer comprises less than 30, even more preferably less than 20, yet more preferably less than 10, most preferably less than 5 of said bilayers (4).

Preferably, in the porous multilayer system according to the invention, the bilayers consisting of two porous layers (L₁) and (L₂) are identical or different from each other, with respect to their compositions and/or thicknesses and/or porosities. More preferably, in the porous multilayer system according to the invention, the bilayers consisting of two porous layers (L₁) and (L₂) are identical to each other, with respect to their compositions and/or thicknesses and/or porosities. However, the invention is not that limited.

Some porous multilayer systems according to the invention may include bilayers which are identical to each other in terms of their compositions and/or thicknesses and/or porosities, together with other bilayers having a constitution different from the first set of bilayers. Suitable combinations of bilayers will be easily identified by those of skill in the art in the light of the present description.

Preferably, in the porous multilayer system according to the invention, the maximum transmittance (Tᵢₙᵢₜᵢₐₗ) and/or the maximum reflectance (R_{final}) of the porous multilayer is obtained upon exposure of the porous multilayer to visible light or infrared light. More preferably, in the porous multilayer system according to the invention, the maximum transmittance (Tᵢₙᵢₜᵢₐₗ) and/or the maximum reflectance (R_{final}) of the porous multilayer is obtained in the visible spectrum.

However, the invention is not that limited. In alternative executions of the invention, the maximum transmittance and/or the maximum reflectance of the porous multilayer may be suitably obtained upon exposure of the porous multilayer to an incident electromagnetic radiation which is located anywhere in the electromagnetic spectrum.

According to another aspect of the present invention, it is provided a method of manufacturing a porous multilayer system as above-described, which comprises the step of:
a) selecting at least one bilayer (4) consisting of two porous layers (L₁) (2) and (L₂) (3) wherein porous layer (L₁) (2) and porous layer (L₂) (3) comprise respectively a host material (h₁) and a host material (h₂), wherein porous layer (L₁) (2) and porous layer (L₂) (3) further comprise respectively a (initial) pore material (p₁) and a (initial) pore material (p₂), said (initial) pore material (p₁) and (initial) pore material (p₂) being air or a (mixture of) inert gas(es), wherein the refractive index (n₁) of the host material (h₁) in porous layer (L₁) (2) is different from the refractive index (n₂) of the host material (h₂) in porous layer (L₂) (3);
b) selecting a suitable composition (C) (7);
c) establishing by theoretical modeling of reflectance (R) and transmittance (T) spectra whether achieving (initial) state (S₁) is possible for a theoretical porous multilayer system (1) comprising said at least one bilayer (4) when composition (C) (7) is absent from said porous multilayer system (1) (i.e. when composition (C) (7) is absent from both porous layer (L₁) (2) and porous layer (L₂) (3), preferably absent from the pores (5) of porous layer (L₁) (2) and the pores (6) of porous layer (L₂) (3));
d) theoretically determining the technical conditions for the porous multilayer system (1) to achieve (initial) state (S₁);
e) determining whether achieving (final) state (S₂) is possible for the same porous multilayer system (1) by introducing a composition (C) (7) into porous layer (L₁) (2) and/or porous layer (L₂) (3), preferably into the pores (5) of porous layer (L₁) (2) and/or the pores (6) of porous layer (L₂) (3);
f) theoretically determining the technical conditions for the porous multilayer system (1) to achieve (final) state (S₂);
g) combining the technical conditions necessary for the same porous multilayer to be capable of (reversibly or irreversibly, preferably reversibly) switching from (initial) state (S₁) (or transparent state) to (final) state (S₂) (or mirror state) by introducing a composition (C) (7) to porous layer (L₁) (2) and/or porous layer (L₂) (3), preferably into the pores (5) of porous layer (L₁) (2) and/or the pores (6) of porous layer (L₂) (3);
h) forming said at least one bilayer (4) consisting of two porous layers (L₁) (2) and (L₂) (3) so as to form a porous multilayer system (1) meeting the combined technical conditions as mentioned above; and
i) optionally, introducing said composition (C) (7) into said porous multilayer system (1), preferably into porous layer (L₁) (2) and/or porous layer (L₂) (3), more preferably into the pores (5) of porous layer (L₁) (2) and/or the pores (6) of porous layer (L₂) (3).

Preferably, in the method according to the invention, (n₁)<(n₂).

Preferably, the porous layer (L₂) of the invention comprises a (total) host material (h_{2,tot}), said (h_{2,tot}) comprising (or consisting of) (a mixture of) (at least) 2 host materials (h₂) and (h₃) (or (h_{2,tot})=(h₂)+(h₃)).

The corresponding (total) dielectric constant (or (total) refractive index n_{2,tot}) is that of (the mixture of) the (at least) 2 host materials (h₂) and (h₃) (or (h_{2,tot})).

More preferably, in the method according to the invention, (n₁)<(n_{2,tot}).

More particularly, the refractive index (n₁) of the host material (h₁) in porous layer (L₁) (2) is lower when compared to refractive index (n_{2,tot}) of (the mixture of) the (at least) 2 host materials (h₂) and (h₃) in porous layer (L₂) (3).

Preferably, in the method according to the invention, the step of theoretically determining the technical conditions for the porous multilayer system to achieve (initial) state (S₁) comprises the step of determining the (initial) pore volume fraction (fₚₒᵣₑ₁) of porous layer (L₁) and/or the (initial) pore volume fraction (fₚₒᵣₑ₂) of porous layer (L₂).

Preferably, in the method according to the invention, porous layer (L₁) comprises a host material (h₁) and a pore material (p₁), and porous layer (L₂) comprises a host material (h₂) and a pore material (p₂), and the method comprises the step of determining the (initial) pore volume fraction (fₚₒᵣₑ₁) of porous layer (L₁) and the (initial) pore volume fraction (fₚₒᵣₑ₂) of porous layer (L₂) such that said (initial) (fₚₒᵣₑ₁) and said (initial) (fₚₒᵣₑ₂) satisfy the following equation:

$${f}_{pore 2} = {f}_{pore 1} \frac{β ( {u}_{1}^{p} ) - β ( {u}_{1}^{h} )}{β ( {u}_{2}^{p} ) - β ( {u}_{2}^{h} )} + \frac{β ( {u}_{1}^{h} ) - β ( {u}_{2}^{h} )}{β ( {u}_{2}^{p} ) - β ( {u}_{2}^{h} )} \qquad ( 1 )$$

wherein

$$β ( {u}_{i}^{p} ) = \frac{1 - {u}_{i}^{p}}{{u}_{i}^{p} ( 1 - {Γ}_{i} ) + 1} ; β ( {u}_{i}^{h} ) = \frac{1 - {u}_{i}^{h}}{{u}_{i}^{h} ( 1 - {Γ}_{i} ) + 1} ;$$

$${u}_{i}^{p} = \frac{\overline{ɛ}}{{ɛ}_{i}^{p}} ; {u}_{i}^{h} = \frac{\overline{ɛ}}{{ɛ}_{i}^{h}} ;$$

wherein i=1 or 2;
wherein ε̅ is the effective dielectric constant (or transparency effective dielectric constant) in (initial) state (S₁); wherein ε̅= n̅², n̅ being the effective refractive index (or transparency effective refractive index) in (initial) state (S₁); wherein εᵢ^{p}=(nᵢ^{p})², εᵢ^{p} being the dielectric constant of pore material (pᵢ) in porous layer (Lᵢ); wherein εᵢ^{h}=(nᵢ^{h})², εᵢ^{h} being the dielectric constant of host material (hᵢ) in porous layer (Lᵢ); and wherein (Γᵢ) is the depolarization factor of porous layer (Lᵢ).

Preferably, in the method according to the invention, the pores present in porous layer (L₁) and/or porous layer (L₂) have a substantially spherical geometry.

Preferably, in the method according to the invention, (initial) pore material (p₁) is air and (initial) pore material (p₂) is air, porous layer (L₁) comprises (or consists of) silicon oxide, porous layer (L₂) comprises (or consists of) titanium oxide, and the step of theoretically determining the technical conditions for the porous multilayer system to achieve state (S₁) comprises the step of determining the (initial) pore volume fraction (fₚₒᵣₑ₁) of porous layer (L₁) and the (initial) pore volume fraction (fₚₒᵣₑ₂) of porous layer (L₂), such that said (initial) (fₚₒᵣₑ₁), and said (initial) (fₚₒᵣₑ₂) satisfy the following general equation:

fₚₒᵣₑ₂=0.424×fₚₒᵣₑ₁+0.560 (2)

More preferably, in the method according to the invention, (initial) pore material (p₁) is air and (initial) pore material (p₂) is air, (the host material (h₁) in) porous layer (L₁) comprises (or consists of) silicon oxide, (the host material (h_{2,tot}) in) porous layer (L₂) comprises (or consists of) titanium oxide (h₂) and aluminum oxide (h₃), and the step of theoretically determining the technical conditions for the porous multilayer system to achieve state (S₁) comprises the step of determining the (initial) pore volume fraction (fₚₒᵣₑ₁) of porous layer (L₁) and the (initial) pore volume fraction (fₚₒᵣₑ₂) of porous layer (L₂), such that said (initial) (fₚₒᵣₑ₁) and said (initial)) (fₚₒᵣₑ₂) satisfy the following general equation:

fₚₒᵣₑ₂=0.518×fₚₒᵣₑ₁+0.472 (2′)

Even more preferably, (the host material (h_{2,tot}) in) porous layer (L₂) (3) comprises (or consists of) 50% TiO₂-50% Al₂O₃.

Preferably, in the method according to the invention, the step of theoretically determining the technical conditions for the porous multilayer system to achieve (final) state (S₂) comprises the step of determining the thickness of porous layer (L₁) and/or the thickness of porous layer (L₂).

Preferably, in the method according to the invention, porous layers (L₁) and (L₂) have respectively a thickness (d₁) and (d₂), and the method comprises the step of determining (d₁) and (d₂), such that (d₁) and (d₂) satisfy the following equation:

λ_{B}=2×ñ×(d₁+d₂) (5)

wherein
λ_{B} is the wavelength at which the porous multilayer system is in state (S₂); and

$$\tilde{n} = \frac{{d}_{1}}{{d}_{1} + {d}_{2}} {\overline{n}}_{1} + \frac{{d}_{2}}{{d}_{1} + {d}_{2}} {\overline{n}}_{2} \qquad ( 6 )$$

wherein n̅₁ and n̅₂ are the effective refractive indexes of respectively layer (L₁) and layer (L₂).

According to yet another aspect of the present invention, it is provided a method of manufacturing a porous multilayer system as above-described method of manufacturing a porous multilayer system, which comprises the step of:
a) selecting at least one bilayer (4) consisting of two porous layers (L₁) (2) and (L₂) (3) wherein porous layer (L₁) (2) and porous layer (L₂) (3) comprise respectively a host material (h₁) and a host material (h₂), wherein porous layer (L₁) (2) and porous layer (L₂) (3) further comprise respectively a (initial) pore material (p₁) and a (initial) pore material (p₂), said (initial) pore material (p₁) or (initial) pore material (p₂) being a (suitable) composition (C) (7) (other than air or a (mixture of) inert gas(es)), wherein the refractive index (n₁) of the host material (h₁) in porous layer (L₁) (2) is different from the refractive index (n₂) of the host material (h₂) in porous layer (L₂) (3);
b) establishing by theoretical modeling of reflectance (R) and transmittance (T) spectra whether achieving (initial) state (S₁′) is possible for a theoretical porous multilayer system (1) comprising said at least one bilayer (4) when composition (C) (7) is present in said porous multilayer system (1), preferably in porous layer (L₁) (2), more preferably in the pores (5) of porous layer (L₁) (2);
c) theoretically determining the technical conditions for the porous multilayer system (1) to achieve (initial) state (S₁′);
d) determining whether achieving (final) state (S₂) is possible for the same porous multilayer system (1) via displacement of composition (C) (7) through said porous multilayer system (1), preferably via displacement of composition (C) (7) from porous layer (L₁) (2) to porous layer (L₂) (3), more preferably via displacement of composition (C) (7) from the pores (5) of porous layer (L₁) (2) to the pores (6) of porous layer (L₂) (3);
e) theoretically determining the technical conditions for the porous multilayer system (1) to achieve (final) state (S₂);
f) combining the technical conditions necessary for the same porous multilayer to be capable of (reversibly or irreversibly, preferably reversibly) switching from (initial) state (S₁′) (or transparent state) to (final) state (S₂) (or mirror state) via displacement of composition (C) (7) through said porous multilayer, preferably via displacement of composition (C) (7) from porous layer (L₁) (2) to porous layer (L₂) (3), more preferably via displacement of composition (C) (7) from the pores (5) of porous layer (L₁) (2) to the pores (6) of porous layer (L₂) (3);
g) forming said at least one bilayer consisting of two porous layers (L₁) (2) and (L₂) (3) so as to form a porous multilayer system (1) meeting the combined technical conditions as mentioned above.

Preferably, in the method according to the invention, (n₁)<(n₂).

Preferably, the porous layer (L₂) of the invention comprises a (total) host material (h_{2,tot}), said (h_{2,tot}) comprising (or consisting of) (a mixture of) (at least) 2 host materials (h₂) and (h₃) (or (h_{2,tot})=(h₂)+(h₃)).

The corresponding (total) dielectric constant (or (total) refractive index n_{2,tot}) is that of (the mixture of) the (at least) 2 host materials (h₂) and (h₃) (or (h_{2,tot})).

More preferably, in the method according to the invention, (n₁)<(n_{2,tot}).

More particularly, the refractive index (n₁) of the host material (h₁) in porous layer (L₁) (2) is lower when compared to refractive index (n_{2,tot}) of (the mixture of) the (at least) 2 host materials (h₂) and (h₃) in porous layer (L₂) (3).

Preferably, in the method according to the invention, the step of theoretically determining the technical conditions for the porous multilayer system to achieve (initial) state (S₁′) comprises the step of determining the (initial) pore volume fraction (fₚₒᵣₑ₁) of porous layer (L₁) and/or the (initial) pore volume fraction (fₚₒᵣₑ₂) of porous layer (L₂).

Preferably, in the method according to the invention, porous layer (L₁) comprises a host material (h₁) and a pore material (p₁), and porous layer (L₂) comprises a host material (h₂) and a pore material (p₂), and the method comprises the step of determining the (initial) pore volume fraction (fₚₒᵣₑ₁) of porous layer (L₁) and the (initial) pore volume fraction (fₚₒᵣₑ₂) of porous layer (L₂) such that said (initial) (fₚₒᵣₑ₁) and said (initial) (fₚₒᵣₑ₂) satisfy the following equation:

$${f}_{pore 2} = {f}_{pore 1} \frac{β ( {u}_{1}^{p} ) - β ( {u}_{1}^{h} )}{β ( {u}_{2}^{p} ) - β ( {u}_{2}^{h} )} + \frac{β ( {u}_{1}^{h} ) - β ( {u}_{2}^{h} )}{β ( {u}_{2}^{p} ) - β ( {u}_{2}^{h} )} \qquad ( 1 )$$

wherein

$$β ( {u}_{i}^{p} ) = \frac{1 - {u}_{i}^{p}}{{u}_{i}^{p} ( 1 - {Γ}_{i} ) + 1} ; β ( {u}_{i}^{h} ) = \frac{1 - {u}_{i}^{h}}{{u}_{i}^{h} ( 1 - {Γ}_{i} ) + 1} ;$$

$${u}_{i}^{p} = \frac{\overline{ɛ}}{{ɛ}_{i}^{p}} ; {u}_{i}^{h} = \frac{\overline{ɛ}}{{ɛ}_{i}^{h}} ;$$

wherein i=1 or 2;
wherein ε̅ is the effective dielectric constant (or transparency effective dielectric constant) in (initial) state (S₁′); wherein ε̅= n̅², n̅ being the effective refractive index (or transparency effective refractive index) in (initial) state (S₁′); wherein εᵢ^{p}=(nᵢ^{p})², εᵢ^{p} being the dielectric constant of pore material (pᵢ) in porous layer (Lᵢ); wherein εᵢ^{h}=(nᵢ^{h})², εᵢ^{h} being the dielectric constant of host material (hᵢ) in porous layer (Lᵢ); and wherein (Γᵢ) is the depolarization factor of porous layer (Lᵢ).

Preferably, in the method according to the invention, the pores present in porous layer (L₁) and/or porous layer (L₂) have a substantially spherical geometry.

Preferably, in the method according to the invention, (initial) pore material (p₁) is water and said (initial) pore material (p₂) is air, porous layer (L₁) comprises (or consists of) silicon oxide, porous layer (L₂) comprises (or consists of) titanium oxide, and the step of theoretically determining the technical conditions for the porous multilayer system to achieve state (S₁′) comprises the step of determining the (initial) pore volume fraction (fₚₒᵣₑ₁) of porous layer (L₁) and the (initial) pore volume fraction (fₚₒᵣₑ₂) of porous layer (L₂), such that said (initial) (fₚₒᵣₑ₁) and said (initial) (fₚₒᵣₑ₂) satisfy the following general equation:

fₚₒᵣₑ₂=0.164×fₚₒᵣₑ₁+0.572 (3)

More preferably, in the method according to the invention, (initial) pore material (p₁) is water and said (initial) pore material (p₂) is air, (the host material (h₁) in) porous layer (L₁) comprises (or consists of) silicon oxide, (the host material (h_{2,tot}) in) porous layer (L₂) comprises (or consists of) titanium oxide (h₂) and aluminum oxide (h₃), and the step of theoretically determining the technical conditions for the porous multilayer system to achieve state (S₁′) comprises the step of determining the (initial) pore volume fraction (fₚₒᵣₑ₁) of porous layer (L₁) and the (initial) pore volume fraction (fₚₒᵣₑ₂) of porous layer (L₂), such that said (initial) (fₚₒᵣₑ₁) and said (initial) (fₚₒᵣₑ₂) satisfy the following general equation:

fₚₒᵣₑ₂=0.164×fₚₒᵣₑ₁+0.481 (3′)

Even more preferably, (the host material (h_{2,tot}) in) porous layer (L₂) (3) comprises (or consists of) 50% TiO₂-50% Al₂O₃.

Alternatively, in the method according to the invention, (initial) pore material (p₁) is air and (initial) pore material (p₂) is water, porous layer (L₁) comprises (or consists of) silicon oxide, porous layer (L₂) comprises (or consists of) titanium oxide, and the step of theoretically determining the technical conditions for the porous multilayer system to achieve state (S₁′) comprises the step of determining the (initial) pore volume fraction (fₚₒᵣₑ₁) of porous layer (L₁) and the (initial) pore volume fraction (fₚₒᵣₑ₂) of porous layer (L₂), such that said (initial) (fₚₒᵣₑ₁) and said (initial) (fₚₒᵣₑ₂) satisfy the following general equation:

fₚₒᵣₑ₂=0.703×fₚₒᵣₑ₁+0.714 (4)

Alternatively, in the method according to the invention, (initial) pore material (p₁) is air and (initial) pore material (p₂) is water, (the host material (h₁) in) porous layer (L₁) comprises (or consists of) silicon oxide, (the host material (h_{2,tot}) in) porous layer (L₂) comprises (or consists of) titanium oxide (h₂) and aluminum oxide (h₃), and the step of theoretically determining the technical conditions for the porous multilayer system to achieve state (S₁′) comprises the step of determining the (initial) pore volume fraction (fₚₒᵣₑ₁) of porous layer (L₁) and the (initial) pore volume fraction (fₚₒᵣₑ₂) of porous layer (L₂), such that said (initial) (fₚₒᵣₑ₁) and said (initial) (fₚₒᵣₑ₂) satisfy the following general equation:

fₚₒᵣₑ₂=0.934×fₚₒᵣₑ₁+0.694 (4′)

More particularly, (the host material (h_{2,tot}) in) porous layer (L₂) (3) comprises (or consists of) 50% TiO₂-50% Al₂O₃.

Preferably, in the method according to the invention, the step of theoretically determining the technical conditions for the porous multilayer system to achieve (final) state (S₂) comprises the step of determining the thickness of porous layer (L₁) and/or the thickness of porous layer (L₂).

Preferably, in the method according to the invention, porous layers (L₁) and (L₂) have respectively a thickness (d₁) and (d₂), and the method comprises the step of determining (d₁) and (d₂), such that (d₁) and (d₂) satisfy the following equation:

λ_{B}=2×ñ×(d₁+d₂) (5)

wherein
λ_{B} is the wavelength at which the porous multilayer system is in state (S₂); and

$$\tilde{n} = \frac{{d}_{1}}{{d}_{1} + {d}_{2}} {\overline{n}}_{1} + \frac{{d}_{2}}{{d}_{1} + {d}_{2}} {\overline{n}}_{2} \qquad ( 6 )$$

wherein n̅ and n̅₂ are the effective refractive indexes of respectively layer (L₁) and layer (L₂).

According to still another aspect, the present invention relates to the use of a porous multilayer system as above-described for the manufacture of a device selected from the group consisting of detecting devices, sensing devices, actuating devices, logical optoelectronic devices, photovoltaic devices, solar cell devices, communication devices, alerting devices, displaying devices, optical devices, smart glazing, hygrochromic devices, and combinations thereof.

Preferably, the porous multilayer system as above-described is used for the manufacture of hygrochromic devices.

According to yet another aspect of the present invention, it is provided a device selected from the group consisting of sensing devices, communication devices, alerting devices, displaying devices, optical devices, logical optoelectronic devices, smart glazing, so-called hygrochromic devices, and combinations thereof; wherein the device comprises a porous multilayer system as above-described. Preferably, the device comprising a porous multilayer system as above-described, is selected from hygrochromic devices.

In the context of the present invention, it has been surprisingly discovered that a suitably designed porous multilayer material may easily (reversibly or irreversibly, preferably reversibly) switch from a state (S₁) to a state (S₂) and/or from a state (S₂) to a state (S₁), as above-described.

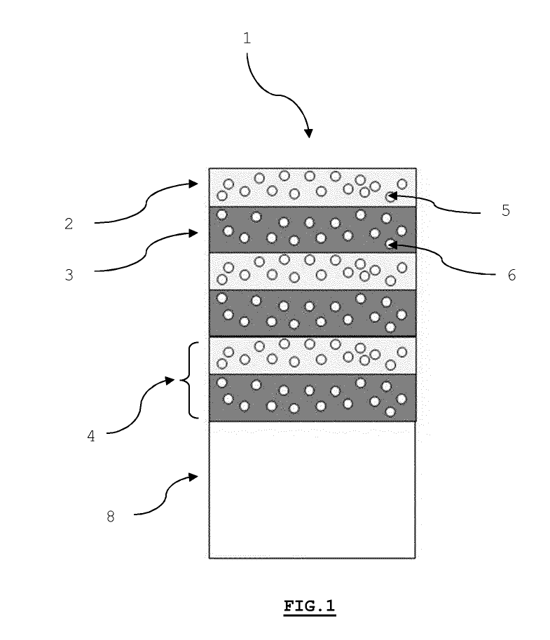

A porous multilayer system (1) according to one preferred embodiment of the present invention and coated on a substrate (8) is schematically depicted in FIG. 1.

FIG. 1 schematically depicts one exemplary execution of a porous multilayer system (1) according to the invention, wherein the porous multilayer system comprises three identical bilayers (4) consisting of porous layer (L₁) (2) and porous layer (L₂) (3), wherein porous layer (L₁) (2) consist substantially of silicon oxide, wherein porous layer (L₂) (3) consist substantially of titanium oxide, wherein porous layer (L₁) (2) comprises pores (5) and porous layer (L₂) (3) comprises pores (6), and wherein pores (5) and (6) are not filled with any suitable composition (C) but filled with ambient air.

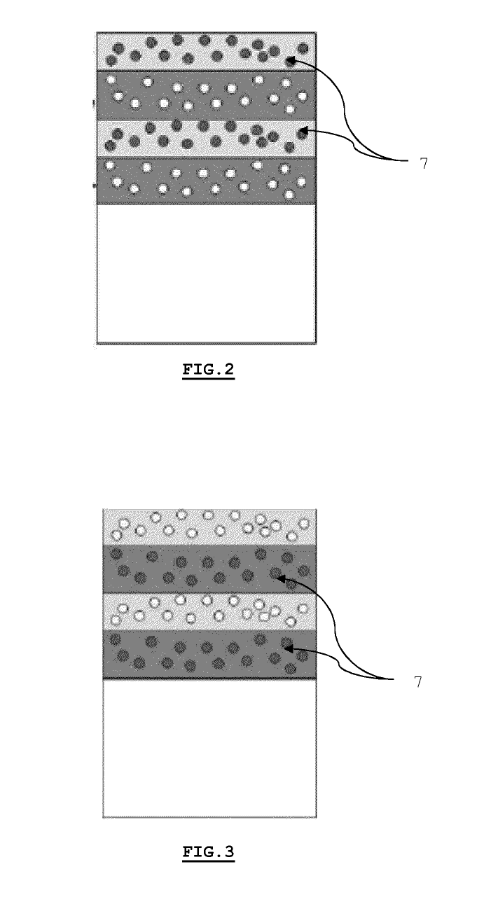

FIG. 2 schematically depicts (part of) the porous multilayer system of FIG. 1 which further comprises a composition (C) (7) in porous layer (L₁) (2) and whereby the porous multilayer system (1) is in state (S₁), i.e. in a transparent state.

FIG. 3 schematically depicts (part of) the porous multilayer system of FIG. 1 which further comprises a composition (C) (7) in porous layer (L₂) (3) and whereby the porous multilayer system (1) is in state (S₂), i.e. in a so-called Bragg mirror state.

As illustrated in FIG. 2 in combination with FIG. 3, the switching from state (S₁) to state (S₂) is ensured via (complete) displacement of composition (C) (7) from the pores (5) of layer (L₁) (2) to the pores (6) of layer (L₂) (3).

### EXAMPLES

### Example 1

### Preparation of Porous Multilayer Systems According to the Invention

Porous layers for use herein are formed by sol-gel technique according to the Evaporation-Induced Self-Assembly (EISA) method well known to those skilled in the art.

### Preparation of Silicon Oxide (SiO₂) Thin Films

Precursor solutions are prepared by addition of the template (surfactant) to the polymeric sols in acidic conditions. In a typical sol preparation, tetraethyl orthosilicate [TEOS, Si(OC₂H₅)₄], distilled water, and absolute ethanol are mixed in the molar ratio 1:10:10. The pH of the solution is adjusted by HCl 37% (pH<2). The prehydrolysed solution is then magnetically stirred for 20 minutes at 40° C. An adequate amount of the template is dissolved in absolute ethanol and added to the prehydrolysed solution. Typically, the final molar ratio is 1 TEOS:20 EtOH:10 H₂O:x Template. The amount of the template added is chosen so as to produce a film with the desired porosity (see Table 1 below for detailed synthesis conditions). The final solution is then aged at 40° C. during 24 hours.

### Preparation of Titanium Oxide (TiO₂) Thin Films

During the hydrolysis of the titanium alkoxides, highly acidic conditions are required to prevent an immediate precipitation of TiO₂. Specifically, an adequate amount of titanium(IV) tetraethoxide (TEOT, 95% Aldrich) is dissolved in concentrated hydrochloric acid (37%) at room temperature. After vigorous stirring during 20 minutes, the hybrid solution is obtained by the addition of dissolved template into ethanol. The final molar ratio of the solution is 1 TEOT:2-4 HCl:9 EtOH:x Template. Table 1 summarizes the nature and the specific amounts of the template (surfactant) used for each porous multilayer system. The solutions are subsequently aged with stirring at room temperature for 3 hours before the films are spin coated onto glass slides or ITO-coated glass.

### Preparation of TiO₂—Al₂O₃ and TiO₂—SiO₂ Thin Films

A series of TiO₂—Al₂O₃ and TiO₂—SiO₂ mixed oxide films, with different (or variable) Al and Si molar fractions, was prepared using one-pot co-condensation.

The TiO₂—Al₂O₃ and TiO₂—SiO₂ mixed oxides with variable Al and Si molar fractions (x) were denoted (1-x) % TiO₂-x % Al₂O₃ and (1-x) % TiO₂-x % SiO₂, respectively, where x is a real number and ranges from (about) 0 to (about) 1, preferably from (about) 0 to (about) 0.8, most preferably from (about) 0 to (about) 0.5. In particular, x=0 corresponds to pure TiO₂.

Under inert atmosphere (Argon), adequate amounts of the titanium(IV) tetraethoxide (TEOT, Sigma-Aldrich) and aluminium isopropoxide (Sigma-Aldrich) or tetraethyl orthosilicate (TEOS, UCB) were dissolved in concentrated hydrochloric acid (37%) at room temperature under magnetic stirring. After vigorous stirring during 20 min, a hybrid solution was obtained by the addition of a template agent, for instance, Pluronic P123 (P123) (Mₙ˜5800, denoted: EO₂₀PO₆₉EO₂₀, Aldrich) dissolved into 1-Butanol.

### Optical Measurements

Transmittance measurements in the 300-900 nm range were carried out using a UV-Vis-NIR spectrophotometer (Cary 5E) at normal incidence angle. Prior to measurements, the samples were washed with ethanol for 2 h using Soxhlet procedure. The transmittance spectra were measured in the transparent (dry) state, which is defined when all the accessible pores of the system were empty (filled with air) and in the reflecting (wet) state, which is defined when all the accessible pores are filled with water. The dry state and wet state were obtained before and after the sample was vigorously washed with water, respectively. The measurement in the wet state was immediately performed after the washing in order to minimize water evaporation from the system.

### Preparation of the Multilayers

The layers are assembled step by step by conventional spin-coating aqueous solutions of silica or titanium sols in air onto glass plates for 30 seconds. Prior to deposition, these substrates are ultrasonically cleaned in detergent, distilled water, acetone, ethanol and in distilled water for 15 minutes each, and then dried at 150° C. The angular velocity range of the spinner is 5000 rpm. After the deposition of each layer, the sample plates are aged in air at room temperature for 12 h, and a subsequent drying of successive steps: 6 hours at 70° C., 3 hours at 150° C. and 2 hours (h) at 200° C. This consolidation temperature is selected to increase the extent of silica and titania cross-linking and ensure to avoid the formation of cracks into the films. This procedure helps to avoid infiltration of a given layer into the preceding one and enables to keep a high optical quality of the building block. Calcinated films are obtained by heating in air at 400° C. for 2-12 hours with a heating rate of 1° C.min⁻¹, which ensures complete removal of organic species.

Exemplary porous multilayer systems according to the invention are formed by superposition of 3, 4 and 6 porous SiO₂/TiO₂ bilayers, preferably by superposition of mesoporous SiO₂/TiO₂ bilayers.

TABLE 1

| Sample | Composition (mol/mol metal) | | | | | | | | Aging |
|---|---|---|---|---|---|---|---|---|---|
| name | Alkoxyde | n (M) | Solvant | | H₂O | HCl | Nature | n(CTAB)/n(Ti) | T |
| TiO₂-P123 | Ti(OEt)₄ | 0.012 | 1-butanol | 18 | — | 4 | P123 | 0.013 | 25° C. |
| TiO₂-CTAB | Ti(OEt)₄ | 0.012 | Ethanol | 9 | — | 2 | CTAB | 0.1 | 25° C. |
| TiO₂-Brij | Ti(OEt)₄ | 0.012 | Ethanol | 9 | — | 2 | Brij56 | 0.05 | 25° C. |
| TiO₂-F127 | Ti(OEt)₄ | 0.012 | Ethanol | 9 | — | 2 | F127 | 0.005 | 25° C. |
| SiO₂-R240 | Si(OC₂H₅) | 0.008 | Ethanol | 20 | 10 | 0.008 | — | — | 40° C. |
| SiO₂- | Si(OC₂H₅) | 0.008 | Ethanol | 20 | 10 | 0.008 | CTAB | 0.1 | 40° C. |
| CTAB | | | | | | | | | |
| SiO₂-P123 | Si(OC₂H₅) | 0.008 | Ethanol | 20 | 10 | 0.008 | P123 | 0.008 | 40° C. |
| SiO₂-Brij | Si(OC₂H₅) | 0.008 | Ethanol | 20 | 10 | 0.008 | Brij56 | 0.05 | 30° C. |
| SiO₂-F127 | Si(OC₂H₅) | 0.008 | Ethanol | 20 | 10 | 0.008 | F127 | 0.005 | 30° C. |
| SiO₂-P240 | Si(OC₂H₅) | 0.008 | Ethanol | 40 | 10 | 0.008 | F68 | 0.01 | 40° C. |
| SiO₂-SDS | Si(OC₂H₅) | 0.008 | Ethanol | 20 | 10 | 0.008 | SDS | 0.1 | 40° C. |
| SiO₂- | Si(OC₂H₅) | 0.008 | Ethanol | 20 | 10 | 0.008 | CTAB/PEG | 0.01/0.5 | 40° C. |
| CTAB/PEG | | | | | | | | | |

### Example 2

### Response of a Porous Multilayer System According to the Invention Towards Water Absorption/Migration

Two multilayer systems according to the invention are prepared using the method as described in Example 1 above. More particularly, two multilayer systems A and B are formed by superposition of three mesoporous SiO₂/TiO₂ bilayers. Depending on the type of surfactant used, different porosities (therefore different effective refractive indexes) are obtained for both SiO₂ and TiO₂ layers.

Table 2 presents average values and standard deviations for the thickness of SiO₂ and TiO₂ layers in samples A and B which comprise three SiO₂/TiO₂ bilayers.

TABLE 2

| Sample | A | B |
|---|---|---|
| Layer type | SiB/TiP | SiS/TiP |
| Thickness of SiO₂ layer (nm) | 73 ± 5 | 98 ± 22 |
| Thickness of TiO₂ layer (nm) | 94 ± 11 | 134 ± 20 |

The characteristics of the constitutive materials of the layers are given in Table 3. Effective refractive index, accessible porosity, average pore diameter are determined by ellipso-porosimetry.

TABLE 3

| | | | | | Average |
|---|---|---|---|---|---|
| | | | Effective | | pore |
| Layer | Host | | refractive | Accessible | diameter |
| type | material | Surfactant | index | porosity | (nm) |
| SiB | SiO₂ | Brij 56 | 1.3900 | 13.5% | 3 |
| SiS | SiO₂ | Sodium Dodecyl | 1.3375 | 6.5% | <1 |
| | | Sulfate | | | |
| TiP | TiO₂ | Pluronic ®P123 | 1.5214 | 44.5% | 14 |

All the layers in samples A and B are mesoporous. The pores of adjacent layers are interconnected. The pore accessibility is evaluated by exposing the mesoporous multilayer to Rhodamine 6G (Rh6G hereafter) as a fluorescent dye solution using procedures well known to those skilled in the art. The results demonstrated that the Rh6G molecule is distributed across the entire multilayer structure, which allowed us to conclude that the entire available porosity of the multilayer is accessible and interconnected.

The porous multilayer samples A and B are immersed into water and their response is characterized by transmittance spectro-photometry. This test allowed checking the sensitivity of the sample to the presence of water in the porous multilayer system. In these experiments, the “dry” state (water composition absent from all the accessible pores of the (porous multilayer) system) and the “wet” state (in this particular case, water composition present in all the accessible pores of the (porous multilayer) system) are achieved through drying and wetting of the sample. The dry state is obtained after rinsing the sample in ethanol (Soxhlet technique) and drying it under controlled N₂ atmosphere. The wet state is obtained after the immersion of the sample into water and subsequent diffusion of the water into the pores. The measurements are performed immediately after the removal of the sample from water in order to minimize the evaporation of water from the pores.

Transmittance measurements are performed at normal incidence using a standard UV-visible-NIR spectrophotometer. Prior to measurements, the sample is cleaned and dried. The absolute transmittance of the sample is determined by adequate calibration. This measurement (T_{d}) corresponds to the “dry” state. The sample is then immersed into water for 15 minutes and let dry through water evaporation in ambient atmosphere. The transmittance is recorded at successive time intervals after the removal of the sample from the water recipient. Once a steady state is achieved in the evolution of the transmittance, the transmittance is measured again and this measurement (Tw) is assigned to the “wet” state.

The first time after removal of the sample from the water recipient, formation of thin water layer is observed at the sample surface. The subsequent evolution of the transmittance corresponds to water diffusion and gradual filling of the pores. This phenomenon is driven by a capillary effect due to the difference of (distribution of) the pores sizes between adjacent layers.

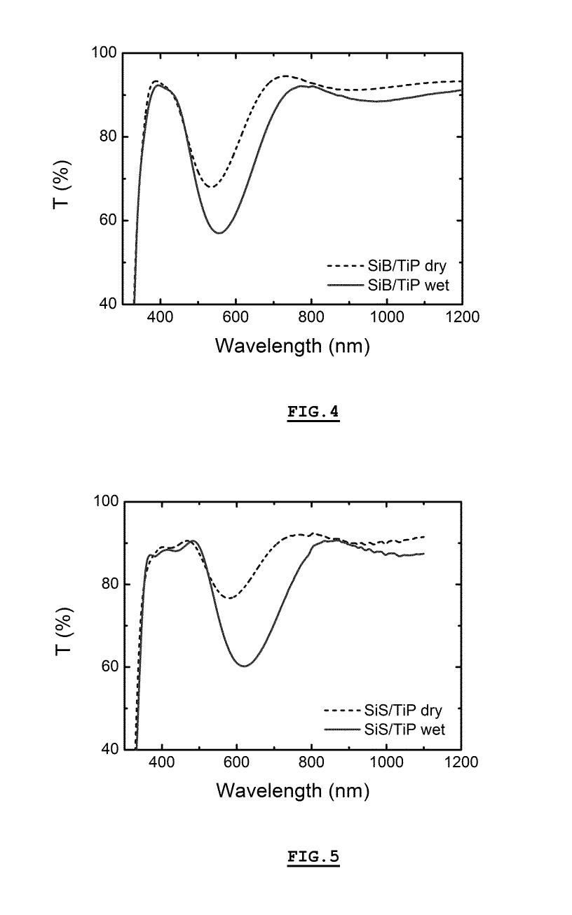

FIG. 4 depicts the transmittance spectrum (at normal incidence) in dry state (dotted-line curve) and wet state (solid-line curve) for porous multilayer sample A. As for FIG. 5, it depicts the transmittance spectrum (at normal incidence) in dry state (dotted-line curve) and wet state (solid-line curve) for porous multilayer sample B.

As illustrated for both samples A and B, changes in the transmittance Bragg peak (both in intensity and wavelength) are observed between the ‘dry’ state and the ‘wet’ state (FIG. 4 and FIG. 5), confirming the sensitivity of the porous multilayer system to the presence/absence of water in the pores. The transmittance ratio, t=T_{w}/T_{d} (T_{w(d)}:minimum transmittance level in the ‘wet’ (‘dry’) state is depending on the sample type: t=0.57/0.68=0.84 for sample A, t=0.60/0.78=0.77 for sample B. The transmittance contrast, ΔT=T_{w}−T_{d}, is also depending on the sample type: ΔT=0.57−0.68=−0.11 (−11%) for sample A, ΔT=0.60−0.78=−0.18 (−18%) for sample B.

Additionally, a change of the area of the Bragg peak before and after the filling of the pores with water is observed for both samples. The full width at half maximum in the wet state is higher than its value in the dry state for each sample. The multilayer system in the wet state blocks the transmission of electromagnetic radiation at longer wavelengths compared to the dry state. The ratio of Bragg peak areas after and before wetting (A_{Wet}/A_{sec}) is higher than 1.0 for all samples, with a value as high as 15 in the case of the porous multilayer sample B.

### Illustration of Adequacy Between Theoretical Predictions for Transmission and Experimental Results

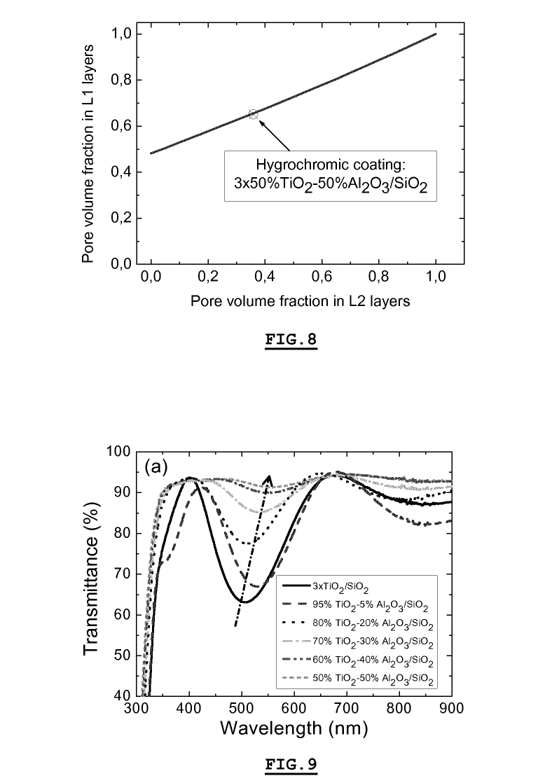

The hygrochromic material was designed by combining (i) suitable distributions of the pore fraction in both low-refractive-index layers and high-refractive-index layers and (ii) adequate ratio of mixed oxides in the high-refractive-index layers. The material was realized as described above. These particular conditions enabled to obtain a colorless (i.e., transparent) material when the pores were empty (i.e., filled with air). The required reduction of the effective refractive index in the high-refractive-index layers (n_{TiO2}=2.5) was obtained by making those layers porous but also by mixing TiO₂ with increasing ratios of low-refractive-index metal oxides such as Al₂O₃ (n_{Al2O3}=1.6) or SiO₂ (n_{SiO2}=1.51). With suitably chosen layer thicknesses, the hygrochromic material exhibited a Bragg reflection in the visible range when the pores were filled with water, whereas it behaved like a homogenized, transparent material when the pores were empty thanks to adequate choice of porosity. The design of the periodic layer system was based on theoretical calculations of the transmittance/reflectance spectra with pores either empty or filled with water. A so-called transparency condition was established on the basis of the Bruggeman effective medium theory applied to porous materials. By imposing Bruggeman's expressions of the effective dielectric constant (ε_{eff}=b_{eff}²) in both SiO₂ and x % TiO₂−(1-x) % Al₂O₃ porous materials to be equal (transparency condition), the relationship between pore fractions was derived, which led to perfect effective refractive index matching (FIG. 8). Any combination of porosities lying on the transparency master curve ensured that an arbitrary layer stack made of these porous materials behaved, as a whole, like a homogenized, transparent material.

FIG. 8 depicts the transparency master curve calculated for L₂ and L₁ layers consisting in, respectively, 50% TiO₂-50% Al₂O₃ and SiO₂ porous oxides. Any combination of porosities lying on that curve ensures perfect effective refractive index matching between both layers when pores are empty (transparent state). The curve of FIG. 8 represents the experimentally realized porosities (hygrochromic coating) in a sample made of 3 bilayers of porous 50% TiO₂-50% Al₂O₃/SiO₂ oxides.

### Example 3a

### Design of a Porous Multilayer System According to the Invention Using Equation (1)

Equation (1) gives the relationship (or transparency condition) between the pore volume fraction in porous layer (L₁) and the pore volume fraction in porous layer (L₂). Said relationship garantees that the effective refractive indexes in both porous layers are equal. As a result, the bilayer (or the stack consisting of porous layers (L₁) and (L₂)) is transparent. In other words, the bilayer behaves as if it were a single layer, i.e. the porous layers (L₁) and (L₂) can not be distinguished since they have both the same effective refractive index.

Host refractive indexes n^{h}ᵢ in Eq. (1): n^{h}₁=1.51 for SiO₂ (porous layer (L₁)) and n^{h}₂=2.56 for TiO₂ (porous layer (L₂)).

Pore refractive indexes n^{P}ᵢ in Eq. (1): In case the pores are filled with air (layer is said to be “dry”), the pore refractive index of the bilayer is equal to n^{p}ᵢ=1.0 (i=1 or 2). In case the pores are filled with water (layer is said to be “wet”), the pore refractive index of the bilayer is equal to n^{p}ᵢ=1.33 (i=1 or 2).

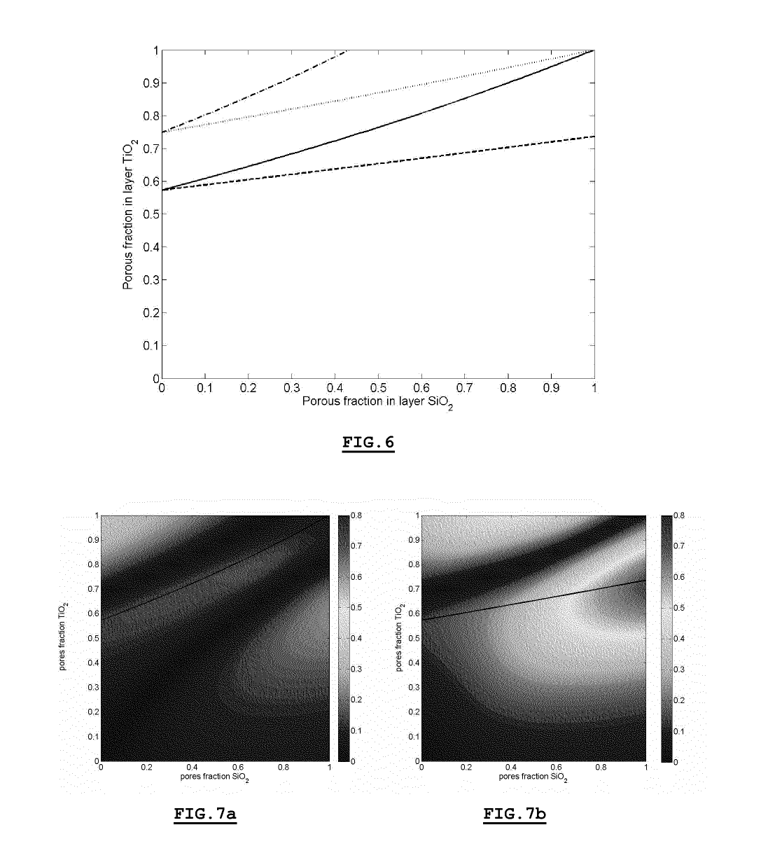

For a bilayer made of SiO₂ (porous layer (L₁)) and TiO₂ (porous layer (L₂)), the transparency condition can be achieved for 4 different combinations of pore filling using either air or water as pore material (FIG. 6):
1) the whole bilayer is “dry” (plain line),
2) the whole bilayer is “wet” (dotted line),
3) SiO₂ layer is “wet”, whereas TiO₂ layer is “dry” (dashed line),
4) SiO₂ layer is “dry”, whereas TiO₂ layer is “wet” (dotted-dash line).

It is to be noted that in case (4), the transparency can not be achieved if the pore volume fraction in the SiO₂ layer is higher than (about) 40%. This situation arises because of the impossibility to further decrease the effective refractive index of TiO₂ layer since it would imply to increase the pore volume fraction above 1 in order to reach the same effective index as in the SiO₂ layer.

The transparency curves for these four combinations can be drawn for any couple of bilayer host materials and air or fluid (as possible pore material). Depending on the host refractive indexes, some combinations will be more convenient for obtaining transparency than others. By more convenient, it is meant that the required couple of pore volume fractions will be easier to obtain experimentally.

FIG. 7a and FIG. 7b each show the transparency relationship (black curve giving the couple of pore volume fractions required to have transparency in one of the four air/fluid combinations) and the maximum reflectance contrast that can be achieved (for arbitrary couples of pore volume fractions) in the case of a porous multilayer system consisting of three 105/65 nm thick SiO₂/TiO₂ bilayers.

On FIG. 7a, the contrast is defined between dry/dry (transparent) and wet/wet (mirror) combinations.

On FIG. 7b, the contrast is defined between wet/dry (transparent) and dry/wet (mirror) combinations.

### Example 3b

### Transmittance Results Obtained with L₂ Containing Mixture of SiO₂ and Al₂O₃

Metal oxide layers with controlled porosity were fabricated as described above. The mesoporous high-refractive-index layers (L₂) were made by co-condensation of titania and alumina (or silica) precursors in the presence of non-ionic templating agent (P123), whereas the low-refractive-index layers (L₁) were made using an ionic templating agent (CTAB). Each templating agent was adequately chosen in order to ensure desired pore ratio and pore size distribution. The Ti/Al (or Ti/Si) molar ratio was varied from about 1% to about 90%, preferably from about 3% to about 70%, most preferable from about 5% to 50%.

The transmittance spectra of mesoporous Bragg stacks are shown in FIG. 9 for various mixed oxide ratio. More particularly, FIG. 9 depicts the transmittance spectra (normal incidence) of mesoporous 1D photonic crystal (PC) coatings in which increasing ratios of alumina oxides were added to the high-refractive-index titania oxide. Using pure oxides in L₁ (SiO₂) and L₂ (TiO₂) layers, the 3-bilayer stack has a Bragg resonance in the visible range, peaking at 508 nm. Raising the ratio of Al₂O₃ or SiO₂ into the L₂ layers drives the system (with empty pores) from a highly reflecting state to a transparent one. Indeed, decreasing the refractive index of the initially high-refractive-index layers (L₂) reduces the contrast between adjacent layers. The Bragg peak intensity is therefore reduced gradually as the ratio of the added oxide is increased, leading to 90% and 86% transmission for respectively 50% TiO₂-50% Al₂O₃/SiO₂ and 50% TiO₂-50% SiO₂/SiO₂ (L₂/L₁) multilayer compositions. These values are close to the maximum transmittance of the bare glass substrate. In comparison, an initial value of 63% was measured for the TiO₂/SiO₂ layer composition. Although L₁ and L₂ layers have different compositions and physical properties, they become optically equivalent (identical effective refractive index) when the pores are empty.

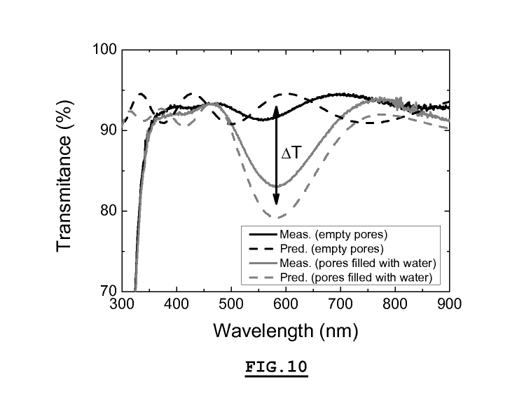

In order to demonstrate the unique ability of mesoporous 1D-PC coatings to switch from transparent (colorless) to reflecting (colored) states, their spectral response following water absorption was examined. Because the reflectance peak that is expected after water infiltration is not very pronounced, the sample was tilted in order to accentuate the color changes by taking advantage of the intrinsic iridescence property of such coatings. When a droplet of water was put on the sample, the coating rapidly adsorbed water and became reflecting and colored. In a control experiment, the non-coated sample showed no coloration when water was put in contact with the surface (bare glass). The transmittance spectra were recorded in the initial, dry state, of the water droplet experiment and in the reflecting, wet state, following water infiltration (FIG. 10). More particularly, FIG. 10 depicts the transmittance spectra of a mesoporous 1D photonic crystal coating before and after filling of the pores with water (solid curves: measurements, dotted curves: theoretical predictions). The composition of the high-refractive-index layers is 50% TiO₂-50% Al₂O₃. The 1D photonic crystal coating consists of three bilayers of 50% TiO₂-50% Al₂O₃ (L₂) and SiO₂ (L₁) oxides on glass substrate.

As expected, the transmittance was reduced around the Bragg peak (583 nm) following water infiltration. These changes were reversible as the sample fully regained its initial transparency upon drying. The pore fractions and pore size distributions in the adjacent layers played a key role in obtaining the hygrochromic effect. The difference in pore size distributions, i.e., smaller pores in the low-refractive-index layers (SiO₂) than in the high-refractive-index layers (mixed TiO₂ and Al₂O₃), enabled the filling of the pores throughout the whole layer system thanks to water capillary attraction. On the other hand, the difference in pore fractions between layers, i.e., higher pore fraction (65%) in 50% TiO₂-50% Al₂O₃ layers and lower pore fraction (36%) in SiO₂ layer, enabled to rise the index contrast between the wetted layers leading to Bragg peak reflection and coloration.

### Example 4

### Theoretical Modeling of Reflectance (R) and Transmittance (T) Spectra

### Transparency Condition

The following example concerns the case of the binary TiO₂/SiO₂ (more generally L₂/L₁) multilayer system. However, the same methodology can be used for the ternary TiO₂—Al₂O₃/SiO₂ system. In the latter case (as described earlier), the host material of L₂ layer is the mixed oxide x % TiO₂-(1-x) % Al₂O₃ (or (1-x) % TiO₂-x % Al₂O₃) instead of TiO₂. The refractive index of L₂ host material used hereafter has then to be replaced by the refractive index of the mixed oxide. The latter is also calculated by the Bruggeman mixing formula, i.e. eq. (7), but with the indices “p” and “h” now designating the two components of the mixed oxide: for example, fₚ=x and fₕ=1-x, εₚ=ε_{TiO2} and εₕ=ε_{Al2O3}. Such calculation is well within the capabilities of the skilled person.

The functional 1D photonic crystals consist in mesoporous TiO₂/SiO₂ multilayer deposited on glass substrate. The high and low index host materials are respectively titanium oxide and silicon oxide. Pore size is of the order of a few nanometers (mesopores). Layers are stacked alternately and are a few tens of nanometer thick in order to produce a Bragg resonance in the visible range. Because the following theoretical considerations are not restricted to a particular combination of high-index/low-index dielectric materials, high-index TiO₂ (low-index SiO₂) layers will be referred as L₂ (L₁) layers.

Since the pore size is much lower than the wavelengths of interest, effective medium theories can be used to calculate the effective relative permittivity (dielectric constant) of the mesoporous materials. In order to establish the transparency condition, the pore volume fractions (porosity) in L₁ and L₂ layers will be varied arbitrarily between 0% and 100% (the former case corresponding to a dense material and the latter case to a hypothetical void material). Since the porosity can take extreme values, the Bruggeman theory is the most appropriate one among various effective medium theories.

A mesoporous material can be regarded as a two-phases mixed medium where one phase is the host material and the other one the pores. fp denotes the pore volume fraction and nₚ the refractive index of the material filling the pores. Either the pores are empty (nₚ=1) or completely filled with water (nₚ=1.33). For the sake of simplicity, the case where pores are partially filled with water is not considered here, although it can be treated by introducing a third phase in the mixed medium.

The refractive index of host material is denoted nₕ. In porous layers L₂, nₕ=2.5 (TiO₂); in porous L₁ layers, nₕ=1.5 (SiO₂). The volume fraction of host material is fₕ=1−fₚ (two-phases mixed medium). The dielectric constant is related to the refractive index by ε=n². According to Bruggeman theory, the effective dielectric constant of the two-phases mixed medium (ε_{eff}) is the solution of the equation

$${f}_{p} \frac{{ɛ}_{p} - {ɛ}_{eff}}{{ɛ}_{eff} + ( {ɛ}_{p} - {ɛ}_{eff} ) L} + {f}_{h} \frac{{ɛ}_{h} - {ɛ}_{eff}}{{ɛ}_{eff} + ( {ɛ}_{h} - {ɛ}_{eff} ) L} = 0 \qquad ( 7 )$$

where L (earlier also denoted as Γ) is the depolarization factor which depends on the shape of the pores. Note that eq. (7) is symmetric: the roles of εₚ and εₕ (fₚ and fₕ) can be interchanged, i.e. the mesoropous material can be regarded either as air voids embedded in a dense material or a skeleton of dense material immerged in air. The solution of this second degree equation takes the explicit form (assuming L=⅓, i.e. spherical pores):

$${ɛ}_{eff} = \frac{1}{4} ( β + \sqrt{{β}^{2} + 8 {ɛ}_{h} {ɛ}_{p}} ) \\ with β = ⌊ ( 3 {f}_{h} - 1 ) {ɛ}_{h} + ( 3 {f}_{p} - 1 ) {ɛ}_{p} ⌋ \qquad ( 8 )$$

The transparency condition is defined as the relationship between the porosities in L₁ and L₂ layer materials such that the effective permittivity (refractive index) values of both materials are identical. In this case, any multilayer system based on arbitrary stacking of L₁ and L₂ materials (in particular a periodic Bragg stack) will behave like an effective, homogenized medium thanks to the removal of wave interferences from layer interfaces (physical layer boundaries can be regarded as virtual, non-operating interfaces in this case). If L₁ and L₂ materials are optically transparent (e.g. mesoporous dielectrics), the whole stack will remain transparent. The transparency condition is derived by writing eq. (7) for both layers (labeled j=1,2) and by imposing ε_{eff},1=ε_{eff},2=ε_{eff}. Introducing the dimensionless variable u=ε_{eff}/ε and the function g(u)=[1−u]/[1+(1/L−1)u], the resulting equation can be written in a compact form:

f_{p,1}g(u_{p,1})+(1−f_{p,1})g(u_{k,1})=f_{p,2}g(u_{p,2})+(1−f_{p,2})g(u_{h,2}) (9)

where the subscripts p and h stand for the pore and host materials, respectively, and the subscripts 1 and 2 stand for layers L₁ and L₂, respectively. From equation (9), one can extract the transparency condition:

$${f}_{p , 2} = {f}_{p , 1} \frac{g ( {u}_{p , 1} ) - g ( {u}_{h , 1} )}{g ( {u}_{p , 2} ) - g ( {u}_{h , 2} )} + \frac{g ( {u}_{h , 1} ) - g ( {u}_{h , 2} )}{g ( {u}_{p , 2} ) - g ( {u}_{h , 2} )} \qquad ( 10 )$$

Titanium oxide (TiO₂) and silicon oxide (SiO₂) host materials are considered with pores either empty or filled with water. Hence, there exist four configurations (“states”) of the porous multilayer system for which, a priori, the transparency condition can be fulfilled, according to filling of L₁ and/or L₂ pores with air or water (FIG. 6).

At first glance, it should be easier to achieve transparency with empty pores in the layers having the highest host refractive index (TiO₂) and water-filled pores in the other layers (SiO₂). Indeed, for given porosities, this configuration helps to decrease the index of L₂ layers and to increase the index of L₁ layers, hence to match them at some point. However, transparency can still be achieved in the three other configurations by playing on porosities (FIG. 6). Nevertheless, since the porosity can never be higher than unity, it may happen that no combination of porosities exists allowing to achieve transparency: this happens with water-filled pores in TiO₂ as far as air-filled pores in SiO₂ exceed 33% in volume fraction (dotted-dash line in FIG. 6). In the limit (unphysical) case where the porosity in SiO₂ reaches 100%, the porosity in TiO₂ reaches 100% if the transparency state is defined by empty pores in both layers (plain line in FIG. 6). This is logical since L₁ material, in this case, is actually a void (i.e. layer entirely filled with air) and the only possibility to match the index in L₂ material is to have a void as well. A similar argument (with water replacing air) applies to the transparency state defined by water-filled pores in both layers (dotted line in FIG. 6). On the other hand, in the same limit case, the porosity in TiO₂ is less than 100% if the transparency state is defined by empty pores in L₂ layer and water-filled pores in L₁ layer (dashed line in FIG. 6). Again, this is logical since L₁ material, in this case, is actually water and matching the water index (n=1.33) can be obtained using a sufficiently large fraction of empty pores in L₂ material. Finally, it should be noted that the transparency master curve, whatever the state is, is well approximated by a linear relationship (FIG. 6). Indeed, the master curve fₚ₂F(fₚ₁) is not strictly linear since the arguments of g functions in eq. (1) depend themselves on fₚ₁ or fₚ₂.

### Calculation of the Reflectance/Transmittance Spectra

The reflectance/transmittance of a multilayer system can be calculated using standard multilayer calculation methods. These methods are based on the exact solutions of Maxwell's equations in stratified (layered) isotropic media. The closed-form expressions of the reflectance/transmittance depend on the wavelength, the incidence angle, incidence light polarization, the refractive indexes of the semi-infinite incidence medium and emergence medium (substrate), the number of layers, their thicknesses and the refractive indexes.

In the present invention, the layer refractive indexes (or permittivities ε=n²) are actually effective values calculated by the Bruggeman mixing formula (layers are not dense but mesoporous). Hence the effective refractive index depends also on the refractive index of the pore filling material, air or water.

The multilayer calculation method used is the so-called continued fraction method, for which the main formula is given hereafter.

For p-polarized light, the reflectance is given by:

$${R}_{p} = {\vert \frac{{ζ}_{p , 0} + i \sqrt{{μ}_{v} / {ɛ}_{v}} cos θ}{{ζ}_{p , 0} - i \sqrt{{μ}_{v} / {ɛ}_{v}} cos θ} \vert}^{2} \qquad ( 11 )$$

where i²=−1, μᵥ and εᵥ are the permeability and permittivity of the incidence medium, is the incidence angle θ and ζ_{p,0} is given by a continued fraction:

$${ζ}_{p , 0} = {a}_{p , 1} - \frac{{b}_{p , 1}^{2}}{{a}_{p , 1} + {a}_{p , 2} - \frac{{b}_{p , 2}^{2}}{{a}_{p , 2} + {a}_{p , 3} - \frac{…}{… + {a}_{p , n}}}} \qquad ( 12 )$$

The quantities a_{p,j} and b_{p,j} are related to the layer thicknesses dⱼ and permittivity εⱼ.

$$\begin{matrix}{a}_{p , j} = \frac{c}{ω} \frac{{k}_{j}}{{ɛ}_{j}} coth ( {k}_{j} {d}_{j} ) & ( 13 ) \\ {b}_{p , j} = \frac{c}{ω} {\frac{{k}_{j}}{{ɛ}_{j}} [ sinh ( {k}_{j} {d}_{j} ) ]}^{- 1} & ( 14 )\end{matrix}$$

where ω is the angular frequency (ω=2πc/λ, λ: wavelength, c: speed of light in vacuum) and kᵢ is the wave-vector component normal to the layer surface in layer #j (k_{y}: component of the wave-vector parallel to the layer interfaces, identical for all layers)

$${k}_{j} = \sqrt{{k}_{y}^{2} - {( ω / c )}^{2} {ɛ}_{j} {μ}_{j}} = \frac{ω}{c} \sqrt{{ɛ}_{v} {μ}_{v} {sin}^{2} θ - {ɛ}_{j} {μ}_{j}} \qquad ( 15 )$$

The reflectance spectrum is defined by Rₚ as a function of λ, all other parameters being fixed.

The transmittance is given by a similar formula:

$${T}_{p} = \frac{4 \sqrt{\frac{{ɛ}_{v}}{{μ}_{v}}} \frac{1}{cos θ} ( \frac{\sqrt{{ɛ}_{sub} {μ}_{sub} - {ɛ}_{v} {μ}_{v} {sin}^{2} θ}}{{ɛ}_{sub}} )}{{\vert 1 + i \sqrt{\frac{{ɛ}_{v}}{{μ}_{v}}} \frac{1}{cos θ} {ζ}_{p , 0} \vert}^{2} {\vert {\prod }_{j = 1}^{N} \frac{{a}_{j} + {ζ}_{p , j}}{{b}_{i}} \vert}^{2}} \qquad ( 16 )$$

where i²=−1, N is the number of layers, μ_{sub} and ε_{sub} are the permeability and permittivity of the emergence medium (substrate).

The transmittance spectrum is defined by Tₚ as a function of λ, all other parameters being fixed.

Similar formulas exist for the case of s-polarized incident light.

1. A porous multilayer system comprising at least one bilayer consisting of a first porous layer and a second porous layer, wherein the first porous layer and the second porous layer comprise respectively a first host material and a second host material, wherein the refractive index of the first host material in the first porous layer is different from the refractive index of the second host material in the second porous layer, wherein the first porous layer and the second porous layer further comprise respectively a first pore material and a second pore material, said porous multilayer system having a reflectance with respect to an incident electromagnetic radiation being minimal, and a transmittance with respect to an incident electromagnetic radiation being maximal, said reflectance and said transmittance corresponding to an initial state of the porous multilayer system, wherein said porous multilayer system is capable of switching from the initial state to a final state, wherein the final state corresponds to the state wherein the reflectance of the porous multilayer system is maximal, and the transmittance is minimal.

2. A porous multilayer system according to claim 1, said first pore material and said second pore material being air or an inert gas, said reflectance with respect to an incident electromagnetic radiation being comprised between 0% to 25% and said transmittance with respect to an incident electromagnetic radiation being comprised between 75% to 100%, said reflectance and said transmittance corresponding to a first state of the porous multilayer system, wherein said porous multilayer system is capable of switching from the first state to the second state by introducing a composition into said porous multilayer system, wherein the second state corresponds to the state wherein the reflectance of the porous multilayer system comprising said composition is comprised between 60% and 100%, and the transmittance is comprised between 0% and 40%.

3. A porous multilayer system according to claim 2, which is further capable of switching from the second state to the first state by removing said composition from said porous multilayer system.

4. A porous multilayer system according to claim 2, which is capable of switching from the first state to the second state by introducing the composition into the first porous layer and/or the second porous layer and/or which is capable of switching from the second state to the first state by removing the composition from the first porous layer and/or the second porous layer.

5. A porous multilayer system according to claim 2, wherein the composition is present in any of the first porous layer and/or the second porous layer.

6. A porous multilayer system according to claim 1, said first pore material or said second pore material comprising a composition, said reflectance with respect to an incident electromagnetic radiation being comprised between 0% to 25% and said transmittance with respect to an incident electromagnetic radiation being comprised between 75% to 100%, said reflectance and said transmittance corresponding to a first state of the porous multilayer system, which is capable of switching from the first state to a second state and/or from the second state to the first state via displacement of the composition through said porous multilayer system, wherein the second state corresponds to the state wherein the reflectance of the porous multilayer system comprising said composition is comprised between 60% and 100%, and the transmittance is comprised between 0% and 40%.

7. A porous multilayer system according to claim 6, wherein said first pore material is the composition and said second pore material is air or inert gas, which is capable of switching from the first state to the second state via complete displacement of said composition from the pores of the first porous layer to the pores of the second porous layer, and which is capable of switching from the second state to the first state via complete displacement of said composition from the pores of the second porous layer to the pores of the first porous layer.

8. A porous multilayer system according to claim 6, wherein said first pore material is air or inert gas and the second pore material is the composition, which is capable of switching from the first state to the second state via complete displacement of said composition from the pores of the second porous layer to the pores of the first porous layer, and which is capable of switching from the second state to the first state via complete displacement of said composition from the pores of the first porous layer to the pores of the second porous layer.

9. A porous multilayer system according to claim 1, wherein (n₁)<(n₂).

10. A porous multilayer system according to claim 1, wherein the first porous layer is hydrophobic and the second porous layer is hydrophilic.

11. A porous multilayer system according to claim 1, wherein the composition is selected from the group consisting of liquid compositions, vapor compositions, and combinations thereof

12. A porous multilayer system according to claim 1, wherein the composition is a liquid composition.

13. A porous multilayer system according to claim 1, wherein the incident electromagnetic radiation ranges from long waves radiations to gamma rays.

14. A porous multilayer system according to claim 1, wherein the first porous layer comprises silicon.

15. A porous multilayer system according to claim 1, wherein the second porous layer comprises titanium.

16. A porous multilayer system according to claim 1, wherein the first porous layer comprises silicon oxide, wherein the second porous layer comprises titanium oxide, and wherein the composition is water.

17. A porous multilayer system according to claim 1, wherein pore volume fraction (fₚₒᵣₑ₁) of the first porous layer and the pore volume fraction (fₚₒᵣₑ₂) of the second porous layer are such that (fₚₒᵣₑ₁) and (fₚₒᵣₑ₂) satisfy the following equation:
$${f}_{pore 2} = {f}_{pore 1} \frac{β ( {u}_{1}^{p} ) - β ( {u}_{1}^{h} )}{β ( {u}_{2}^{p} ) - β ( {u}_{2}^{h} )} + \frac{β ( {u}_{1}^{h} ) - β ( {u}_{2}^{h} )}{β ( {u}_{2}^{p} ) - β ( {u}_{2}^{h} )} \qquad ( 1 )$$
wherein
$$β ( {u}_{i}^{p} ) = \frac{1 - {u}_{i}^{p}}{{u}_{i}^{p} ( 1 - {Γ}_{i} ) + 1} ; β ( {u}_{i}^{h} ) = \frac{1 - {u}_{i}^{h}}{{u}_{i}^{h} ( 1 - {Γ}_{i} ) + 1} ;$$
$${u}_{i}^{p} = \frac{\overline{ɛ}}{{ɛ}_{i}^{p}} ; {u}_{i}^{h} = \frac{\overline{ɛ}}{{ɛ}_{i}^{h}} ;$$
wherein i=1 or 2;
wherein ε̅ is the effective dielectric constant in a first state; wherein ε̅= n̅², n̅ being the effective refractive index in the first state wherein εᵢ^{p}=(nᵢ^{p})², εᵢ^{p} being the dielectric constant of pore material (pᵢ) in porous layer (Lᵢ); wherein εᵢ^{h}=(nᵢ^{h})², εᵢ^{h} being the dielectric constant of host material (hᵢ) in porous layer (Lᵢ); and wherein (Γᵢ) is the depolarization factor of porous layer (Lᵢ).

18. A porous multilayer system according to claim 2, wherein the first porous layer comprises silicon oxide and the second porous layer comprises titanium oxide, wherein the first pore material is air and the second pore material is air, and wherein a pore volume fraction (fₚₒᵣₑ₁) of the first porous layer and a pore volume fraction (fₚₒᵣₑ₂) of the second porous layer are such that (fₚₒᵣₑ₁) and (fₚₒᵣₑ₂) satisfy the following equation:
fₚₒᵣₑ₂=0.424×fₚₒᵣₑ₁+0.560 (2)

19. A porous multilayer system according to claim 6, wherein the first porous layer comprises silicon oxide and the second porous layer comprises titanium oxide, wherein the first pore material is water and the second pore material is air, and wherein a pore volume fraction (fₚₒᵣₑ₁) of the first porous layer and the a pore volume fraction (fₚₒᵣₑ₂) of the second porous layer are such that (fₚₒᵣₑ₁) and (fₚₒᵣₑ₂) satisfy the following equation:
fₚₒᵣₑ₂=0.164×fₚₒᵣₑ₁+0.572 (3)

20. A porous multilayer system according to claim 6, wherein the first porous layer comprises silicon oxide and the second porous layer comprises titanium oxide, wherein the first pore material is air and the second pore material is water, and wherein a pore volume fraction (fₚₒᵣₑ₁) of the first porous layer and a pore volume fraction (fₚₒᵣₑ₂) of the second porous layer are such that (fₚₒᵣₑ₁) and (fₚₒᵣₑ₂) satisfy the following equation:
fₚₒᵣₑ₂=0.703×fₚₒᵣₑ₁+0.714 (4)

21. A porous multilayer system according to claim 1, which comprises any of 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 bilayers consisting of the first porous layer and the second porous layer.

22. A method of manufacturing a porous multilayer system according to claim 2, which comprises the step of:
a) selecting at least one bilayer consisting of the first porous layer and the second porous layer, wherein the first porous layer and the second porous layer comprise respectively the first host material and the second host material, wherein the first porous layer and the second porous layer further comprise respectively a first pore material and a second pore material, said first pore material and said second pore material being air or an inert gas, wherein the refractive index of the first host material in the first porous layer is different from the refractive index (n₂) of the second host material in the second porous layer;
b) selecting the composition;
c) establishing by theoretical modeling of reflectance and transmittance spectra whether achieving the first state is possible for a theoretical porous multilayer system comprising said at least one bilayer when the composition is absent from said porous multilayer system;
d) theoretically determining the technical conditions for the porous multilayer system to achieve the first state;
e) determining whether achieving the second state is possible for the same porous multilayer system by introducing the composition into the first porous layer and/or the second porous layer;
f) theoretically determining the technical conditions for the porous multilayer system to achieve the second state;
g) combining technical conditions necessary for the porous multilayer to be capable of switching from the first state to the second state by introducing the composition to the first porous layer and/or the second porous layer;
h) forming said at least one bilayer consisting of the first porous layer and the second porous layer so as to form a porous multilayer system meeting the combined technical conditions.

23. A method of manufacturing a porous multilayer system according to claim 6, which comprises the step of:
a) selecting at least one bilayer consisting of the first porous layer and the second porous layer, wherein the first porous layer and the second porous layer comprise respectively a first host material and a second host material, wherein the first porous layer and the second porous layer further comprise respectively the first pore material and the second pore material, said first pore material or said second pore material being the composition, wherein the refractive index of the first host material in the first porous layer is different from the refractive index of the second host material in the second porous layer;
b) establishing by theoretical modeling of reflectance and transmittance spectra whether achieving the first state is possible for a theoretical porous multilayer system comprising said at least one bilayer when the composition is present in said porous multilayer system;
c) theoretically determining technical conditions for the porous multilayer system to achieve the first state;
d) determining whether achieving the second state is possible for the porous multilayer system via displacement of the composition through said porous multilayer system;
e) theoretically determining the technical conditions for the porous multilayer system to achieve the second state;
f) combining the technical conditions necessary for the porous multilayer to be capable of switching from the first state to the second state via displacement of the composition through said porous multilayer;
g) forming said at least one bilayer consisting of the first porous layer and the second porous layer so as to form a porous multilayer system meeting the combined technical conditions.

24. Method using a porous multilayer system according to claim 1 for manufacturing a device selected from the group consisting of detecting devices, sensing devices, actuating devices, logical optoelectronic devices, photovoltaic devices, solar cell devices, communication devices, alerting devices, displaying devices, optical devices, smart glazing, hygrochromic devices, and combinations thereof.

25. A porous multilayer system according to claim 2, said first pore material and said second pore material being air or an inert gas, said reflectance with respect to an incident electromagnetic radiation being 0% and said transmittance with respect to an incident electromagnetic radiation being 100%, said reflectance and said transmittance corresponding to the first state of the porous multilayer system, wherein said porous multilayer system is capable of switching from the first state to the second state by introducing the composition into said porous multilayer system, wherein the second state corresponds to a state wherein the reflectance of the porous multilayer system comprising said composition is 100% and the transmittance is 0%.

26. A porous multilayer system according to claim 25, which is further capable of switching from the second state to the first state by removing said composition from said porous multilayer system.

27. A porous multilayer system according to claim 3, which is capable of switching from the first state to the second state by introducing the composition into the first porous layer and/or the second porous layer, and/or which is capable of switching from the second state to the first state by removing the composition from the first porous layer and/or the second porous layer.

28. A porous multilayer system according to claim 25, which is capable of switching from the first state to the second state by introducing the composition into the first porous layer and/or the second porous layer, and/or which is capable of switching from the second state to the first state by removing the composition from the first porous layer and/or the second porous layer.

29. A porous multilayer system according to claim 26, which is capable of switching from the first state to the second state by introducing the composition into the first porous layer and/or the second porous layer, and/or which is capable of switching from the second state to the first state by removing the composition from the first porous layer and/or the second porous layer.

30. A porous multilayer system according to claim 6, said first pore material or said second pore material being the composition, said porous multilayer system comprising said composition having the reflectance with respect to an incident electromagnetic radiation being 0% and the transmittance with respect to an incident electromagnetic radiation being 100%, said reflectance and said transmittance corresponding to the first state of the porous multilayer system, which is capable of switching from the first state to the second state and/or from the second state to the first state via displacement of the composition through said porous multilayer system, wherein the second state corresponds to the state wherein the reflectance of the porous multilayer system comprising said composition is 100% and the transmittance is 0%.

31. A porous multilayer system according to claim 12, wherein composition is selected from aqueous compositions.

32. A porous multilayer system according to claim 12, wherein composition is water.

33. A porous multilayer system according to claim 13, wherein the incident electromagnetic radiation ranges from microwaves to X-rays radiations.

34. A porous multilayer system according to claim 13, wherein the incident electromagnetic radiation ranges from infrared to ultraviolet radiations.

35. A porous multilayer system according to claim 13, wherein the incident electromagnetic radiation is visible light.

36. A porous multilayer system according to claim 14, wherein the first porous layer comprises silicon oxide.

37. A porous multilayer system according to claim 15, wherein the second porous layer comprises titanium oxide.

38. A porous multilayer system according to claim 21, which comprises less than 30 of said bilayers.

39. A porous multilayer system according to claim 21, which comprises less than 20 of said bilayers.

40. A porous multilayer system according to claim 21, which comprises less than 10 of said bilayers.

41. A porous multilayer system according to claim 21, which comprises less than 5 of said bilayers.

42. A method of manufacturing a porous multilayer system according to claim 22, which comprises after step h) a step i) introducing said composition into said porous multilayer system.

43. A method of manufacturing a porous multilayer system according to claim 42, wherein said composition is introduced into the first porous layer and/or the second porous layer.

44. A method of manufacturing a porous multilayer system according to claim 3, which comprises the step of:
a) selecting at least one bilayer consisting of a first porous layer and a second porous layer, wherein the first porous layer and the second porous layer comprise respectively a first host material and a second host material, wherein the first porous layer and the second porous layer further comprise respectively a first pore material and a second pore material, said first pore material and said second pore material being air or an inert gas, wherein a refractive index of the first host material in the first porous layer is different from a refractive index of the second host material in the second porous layer;
b) selecting a suitable composition;
c) establishing by theoretical modeling of reflectance and transmittance spectra whether achieving a first state is possible for a theoretical porous multilayer system comprising said at least one bilayer when said composition is absent from said porous multilayer system;
d) theoretically determining the technical conditions for the porous multilayer system to achieve the first state;
e) determining whether achieving a second state is possible for the porous multilayer system by introducing the composition into the first porous layer and/or the second porous layer;
f) theoretically determining the technical conditions for the porous multilayer system to achieve the second state;
g) combining the technical conditions necessary for the same porous multilayer to be capable of switching from the first state to the second state by introducing the composition to the first porous layer and/or the second porous layer;
h) forming said at least one bilayer consisting of the first porous layer and the second porous layer so as to form the porous multilayer system (1) meeting the combined technical conditions.

45. A method of manufacturing a porous multilayer system according to claim 44, which comprises after step h) a step i) introducing said composition into said porous multilayer system.

46. A method of manufacturing a porous multilayer system according to claim 45, wherein said composition is introduced into the first porous layer and/or the second porous layer.

47. A method of manufacturing a porous multilayer system according to claim 4, which comprises the step of:
a) selecting at least one bilayer consisting of the first porous layer and the second porous layer, wherein the first porous layer and the second porous layer comprise respectively the first host material and the second host material, wherein the first porous layer and the second porous layer further comprise respectively the first pore material and the second pore material, said first pore material and said second pore material being air or an inert gas, wherein the refractive index of the first host material in the first porous layer is different from the refractive index of the second host material in the second porous layer;
b) selecting the suitable composition;
c) establishing by theoretical modeling of reflectance and transmittance spectra whether achieving the first state is possible for a theoretical porous multilayer system comprising said at least one bilayer when said composition is absent from said porous multilayer system;
d) theoretically determining the technical conditions for the porous multilayer system to achieve the first state;
e) determining whether achieving the second state is possible for the porous multilayer system by introducing the composition into the first porous layer and/or the second porous layer;
f) theoretically determining the technical conditions for the porous multilayer system to achieve the second state;
g) combining the technical conditions necessary for the porous multilayer to be capable of switching from the first state to the second state by introducing the composition to the first porous layer and/or the second porous layer;
h) forming said at least one bilayer consisting of the first porous layer and the second porous layer so as to form the porous multilayer system meeting the combined technical conditions.

48. A method of manufacturing a porous multilayer system according to claim 47, which comprises after step h) a step i) introducing said composition into said porous multilayer system.

49. A method of manufacturing a porous multilayer system according to claim 48, wherein said composition is introduced into the first porous layer and/or the second porous layer.

50. A method of manufacturing a porous multilayer system according to claim 5, which comprises the step of:
a) selecting at least one bilayer consisting of the first porous layer and the second porous layer wherein the first porous layer and the second porous layer comprise respectively the first host material and the second host material, wherein the first porous layer and the second porous layer further comprise respectively the first pore material and the second pore material, said first pore material and said second pore material being air or an inert gas, wherein the refractive index of the first host material in the first porous layer is different from the refractive index of the second host material in the second porous layer;
b) selecting the composition;
c) establishing by theoretical modeling of reflectance and transmittance spectra whether achieving the first state is possible for a theoretical porous multilayer system comprising said at least one bilayer when the composition is absent from said porous multilayer system;
d) theoretically determining the technical conditions for the porous multilayer system to achieve the first state;
e) determining whether achieving the second state is possible for the same porous multilayer system by introducing the composition into the first porous layer and/or the second porous layer;
f) theoretically determining the technical conditions for the porous multilayer system to achieve the second state;
g) combining the technical conditions necessary for the same porous multilayer to be capable of switching from the first state to the second state by introducing the composition to the first porous layer and/or the second porous layer;
h) forming said at least one bilayer consisting of the first porous layer and the second porous layer so as to form a porous multilayer system meeting the combined technical conditions.

51. A method of manufacturing a porous multilayer system according to claim 50, which comprises after step h) a step i) introducing said composition into said porous multilayer system.

52. A method of manufacturing a porous multilayer system according to claim 51, wherein said composition is introduced into the first porous layer and/or the second porous layer.

53. A method of manufacturing a porous multilayer system according to claim 23, comprising
in step b) establishing by theoretical modeling of reflectance and transmittance spectra whether achieving the first state is possible for a theoretical porous multilayer system comprising said at least one bilayer when said composition is present in the first porous layer;
in step d) determining whether achieving the second state is possible for the porous multilayer system via displacement of the composition from the first porous layer to the second porous layer;
in step f) combining the technical conditions necessary for the porous multilayer to be capable of switching from the first state to the second state via displacement of the composition from the first porous layer to the second porous layer.

54. Method according to claim 24 for manufacturing hygrochromic devices.
